(19) United States
(12) Patent Application Publication
(10) Pub. No.: US 2014/0074589 A1
(43) Pub. Date: Mar. 13, 2014

(54) SYSTEM AND METHOD FOR THE SELECTION AND DELIVERY OF A CUSTOMIZED CONSUMER OFFER OR ENGAGEMENT DIALOG BY A LIVE CUSTOMER SERVICE REPRESENTATIVE IN COMMUNICATION WITH A CONSUMER

(71) Applicants: Aaron David Nielsen, Langley (CA); Michael Rankin Day, Victoria (CA); Qiao Pang, Surrey (CA); Sergey Sirotkin, Port Moody (CA)

(72) Inventors: Aaron David Nielsen, Langley (CA); Michael Rankin Day, Victoria (CA); Qiao Pang, Surrey (CA); Sergey Sirotkin, Port Moody (CA)

(21) Appl. No.: 14/017,219

(22) Filed: Sep. 3, 2013

Related U.S. Application Data
(60) Provisional application No. 61/696,191, filed on Sep. 2, 2012.

(51) Int. Cl. G06Q 30/02

(52) U.S. Cl. CPC G06Q 30/0271
USPC 705/14.43; 705/14.41; 705/14.67

(57) ABSTRACT

A computer-implementable method for selection and delivery of a customized consumer offer or engagement dialog by a live customer service representative (CSR) in communication with said consumer comprises upon a first communication from the consumer to the CSR, enabling the CSR to acquire from a first computer system at least one identifying feature of said consumer; using the at least one identifying feature to generate automatically, without CSR involvement, a search of the internet, via a second computer system, to acquire at least one current, real time internet content cue relating to said consumer, said real time internet content cue being collected while the CSR maintains engagement with the consumer; processing, via the second computer system, the at least one identifying feature and the at least one current, real time internet content cue to generate a consumer profile for said consumer; analyzing the consumer profile to create customized consumer offer or engagement dialog; and prompting the CSR to provide the customized offer or engagement dialog to the consumer.

### FIELD OF THE INVENTION

This invention relates to improvements in the marketing and in particular to smart targeting of offers to consumers.

### BACKGROUND OF THE INVENTION

In today's competitive global marketplace, all successful companies must excel at marketing, and marketing objectives are ever more ambitious. Their goals include traditional selling, up-selling and cross-selling, plus brand recognition, as well as various forms of loyalty programs, and in the social media realm, getting good product reviews on websites, building followers on social media, and generating postings.

It cannot be ignored that social media outlets have become a fundamental means for social interaction between users across the globe. Through social media outlets, users are able to share information regarding almost any topic. For example, a user may use social media outlets to share information regarding daily activities, educational information, information regarding professional services, information regarding product reviews, etc. . . . . Furthermore, in this context, a user may establish a social profile comprising data that identifies various aspects of the user to associated users, such as demographic information, a set of interests such as hobbies or professional skills, and a set of resources that are interesting to the user

With the broadening of the marketing realm, accompanying the explosive growth of social media generally, has been a corresponding explosion of advertising of all types (television, direct mail, newsletters, emails, web ads, telemarketing). The result of all of this intrusive marketing is customer frustration, low conversion of marketing investment, and even brand damage.

One approach companies have taken online to achieve greater relevance with their ads is to tailor them to a person's assumed interests, based on either specific actions they take (e.g., a Google search query), information they post about themselves on a social media site (e.g., Facebook), or inferred through programmed analysis of the content of their social media stream (e.g., Twitter). This is more effective than generic advertising, but can still readily get lost in the plethora of ads people see every day. In other words, people tune out of ads with which they are bombarded via social media. This is even more so if such ads are not properly targeted to the subject.

It is an object of the present invention to obviate or mitigate some of the above disadvantages.

### SUMMARY OF THE INVENTION

The present invention provides a computer-implemented method for dynamic offer generation and content delivery to a customer by a customer service representative, such method offering an inducement to an inbound customer contact wherein the offer is not random but is selected by constructing, in real time, a customer profile using a plurality of harvested customer profile data and then matching the profile to an optimal marketing campaign based on one or more business rules and protocols and wherein an accepted offer by the customer is transmitted to the customer via his/her preferred communication means.

The present invention provides, in one aspect, a computer-implementable method for selection and delivery of a customized offer to a consumer by a live customer service representative (CSR) in communication with said consumer comprising:

a) upon a first communication from the consumer to the CSR, enabling the CSR to acquire from a first computer system at least one identifying feature of said consumer;
b) using the at least one identifying feature to generate automatically, without CSR involvement, a search of the internet, via a second computer system, to acquire at least one current, real time Internet content cue relating to said consumer, said real time Internet content cue being collected while the CSR maintains engagement with the consumer;
c) processing, via the second computer system, the at least one identifying feature and the at least one current, real time Internet content cue to generate a consumer profile for said consumer;
d) analyzing the consumer profile to create customized consumer offer or engagement dialog; and
e) prompting the CSR to provide the customized consumer offer or engagement dialog to the consumer.

The present invention provides, in another aspect a machine implemented system that selects and delivers a customized offer to a consumer via a live customer service representative (CSR) in communication with said consumer comprising the following machine executable components:

a) a device for live communication between the CSR and the consumer;
b) a first processor to acquire at least one identifying feature of said consumer;
c) a second processor to search the Internet and to acquire at least one current, real time Internet content cue relating to said consumer, to generate a consumer profile for said consumer based upon the at least one real time internet content cue and the at least one identifying feature and creating a customized consumer offer or engagement dialog based at least in part on the consumer profile; and
d) an interface for the CSR to add data relating to the consumer and to view the consumer profile and the customized consumer offer or engagement dialog.

The present invention provides, in another aspect, a networked apparatus for use by a customer service representative (CSR) in live communication with a consumer comprising: a memory; a processor; a communicator; a display; and a data receiving module to receive a consumer profile and customized consumer offer or engagement dialog for said consumer, said profile generated by the analysis of at least one identifying feature and the at least one current, real time internet content cue related to said consumer, said display comprising an interface for the CSR to add data relating to the consumer and to view the consumer profile and the customized offer or engagement dialog.

The present invention provides, in another aspect, non-transitory, computer-readable storage media for tangibly storing thereon computer readable instructions for a method for the selection and delivery of a customized offer or engagement dialog to a consumer by a live customer service representative (CSR) in communication with said consumer, said method comprising: a) upon a first communication from the consumer to the CSR, enabling the CSR to acquire from a first computer system at least one identifying feature of said consumer; b) using the at least one identifying feature to generate automatically, without CSR involvement, a search of the internet, via a second computer system, to acquire at least one current, real time internet content cue relating to said consumer, said real time internet content cue being collected while the CSR maintains engagement with the consumer; c) processing, via the second computer system, the at least one identifying feature and the at least one current, real time internet content cue to generate a consumer profile for said consumer; d) analyzing the consumer profile to create customized consumer offer or engagement dialog; and e) prompting the CSR to provide the customized offer or engagement dialog to the consumer.

In a further aspect of the invention, there is provided a graphical user interface for CSR to use to apply the method as described herein.

The advantages of the method and system of the present invention are significant. Using such method and system, there is generated a dynamic offer and delivery content for a customer service representative to offer an inducement to an inbound customer contact. The offer is selected by constructing in real time a complete customer profile using, for example, CRM data, marketing history, product data, and harvested online social and demographic data, and then matching the profile to an optimal marketing campaign based on one or more business rules and protocols. An accepted offer is transmitted to the customer via his/her preferred communication option (for example, email, Facebook, Twitter, text message). Importantly, at least one identifying feature and the at least one current, real time internet content cue are used to generate a consumer profile for said consumer, said profile at least partially driving the type, scope and character of the offer. The offer is essentially “bespoke” to that consumer, by using data related to the consumer, collected in real time, largely without direct input from the consumer, while the consumer is otherwise engaging with the CSR but unaware that useful personalized information is being collected.

The method and system of the present invention capitalize on:

1) consumer initiated contact with the CSR and the concomitant benefit of the CSR possibly already knowing at least some characteristics of the consumer on the basis of a prior relationship; and
2) live during a call, real time mining of the internet for internet content cues relating to the consumer, such cues being used to select a best offer for the CSR to present to the consumer.

These and other advantages of the invention will become apparent throughout the present disclosure.

### BRIEF DESCRIPTION OF THE FIGURES

FIG. 1 is a schematic view of the a machine-implemented system used to generate a dynamic offer and delivery content for Customer Service Representative;

FIG. 2 is a flow chart of the present invention depicting the process of creating a new offer or “campaign”;

FIG. 3 is a representation of a console log-in page;

FIG. 4 is a representation of a new campaign page;

FIG. 5 is a representation of a new campaign attributes page;

FIG. 6 is a representation of a new campaign condition and groups page;

FIGS. 7a and 7b is a representation of a delivery options campaign page;

FIG. 8 is a representation of a campaign tracking code page;

FIG. 9 is a flow chart of a campaign management application selecting a campaign to provide for a particular customer;

FIG. 10 is a flow chart showing how a campaign in administered to a customer by the CCP's CCRs;

FIG. 11 shows a collapsed view of a client application user interface which a CSR accesses via their local terminal;

FIG. 12 shows an expanded view of a client application user interface;

FIG. 13 is a representation of a dashboard for tracking the results of the customized offers and engagement dialogs;

FIG. 14 shows three states of the engagement dialog process (A) dialog presentation (B) engagement tracking (C) historical learnings.

### DETAILED DESCRIPTION OF THE INVENTION

A method, system and apparatus for the selection and delivery of a customized consumer offer or engagement dialog by a live customer service representative (CSR) in communication with said consumer are described herein. A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### TERMS

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

The term “device” and “mobile device” refer herein to any personal digital assistants, Smart phones, other cell phones, tablets and the like.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

The terms “offer” and “campaign” may be used interchangeably.

The terms “customer” and “consumer” may be used interchangeably.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or machine or distributed across several devices or machines.

In a preferred form, internet content cues are acquired from a social media outlet, most preferably from collaborative projects, social networking sites, media sharing sites, review/opinion sharing sites, Internet forums, blogs, content communities, virtual game worlds, and virtual communities. Most preferably, the internet content cue is acquired from a social media outlet selected from the group consisting of Wikipedia, Myspace, Twitter, Facebook, HootSuite, Flickr, YouTube, Pinterest, Google+, Epinions, WikiAnswers, weblogs, social blogs, and microblogs.

As used herein, a “social media outlet” may include any media outlet configured to facilitate interaction and/or the distribution of communications and/or content between one or more users. For example, social media outlets may include Internet-based applications configured to facilitate the creation and exchange of user-generated content. In some examples, social media outlets may include collaborative projects (e.g., Wikipedia), social networking sites (e.g., Myspace, Twitter, Facebook, Pinterest), media sharing sites (e.g., Flickr, YouTube), review/opinion sharing sites (e.g., Epinions, WikiAnswers), Internet forums, blogs (e.g., weblogs, social blogs, microblogs), content communities, virtual game worlds, virtual communities, and/or any other type of social media outlet. The social media outlets may be configured to facilitate the distribution of posts (e.g., wall postings, blog postings), email, instant messages, and/or any other suitable communications or other content.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b). The title of the present application and headings of sections provided in the present application are for convenience only, and are not to be taken as limiting the disclosure in any way.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

In general, an input interface provides an interface for a CSR to receive information from, for example, the CRM database, call context data, and internet content cues. Input interface (also called graphical user interface) may use various input technologies including, but not limited to, a keyboard, a pen and touch screen, a mouse, a track ball, a touch screen, a keypad, one or more buttons, etc. to allow the CSR to enter information into user device or to make selections presented in a user interface displayed on display. The same interface may support both input interface and output interface. For example, a touch screen both allows user input and presents output to the user. CSR device may have one or more input interfaces that use the same or a different input interface technology. Keyboard, the pen and touch screen, mouse, the track ball, the touch screen, the keypad, the one or more buttons, further may be accessible by CSR device through a communication interface.

Computer-readable medium is an electronic holding place or storage for information so that the information can be accessed by processor as known to those skilled in the art. Computer-readable medium can include, but is not limited to, any type of random access memory (RAM), any type of read only memory (ROM), any type of flash memory, etc. such as magnetic storage devices (e.g., hard disk, floppy disk, magnetic strips, . . . ), optical discs (e.g., CD, DVD, . . . ), smart cards, flash memory devices, etc. User device may have one or more computer-readable media that use the same or a different memory media technology. User device also may have one or more drives that support the loading of a memory media such as a CD or DVD. Computer-readable medium may provide the electronic storage medium for database that may optionally be stored on user device.

Communication interface provides an interface for receiving and transmitting data between devices using various protocols, transmission technologies, and media as known to those skilled in the art. Communication interface may support communication using various transmission media that may be wired or wireless. CSR device may have one or more communication interfaces that use the same or a different communication interface technology. Data and messages may be transferred between CSR system and data processing system and/or between another user system or the plurality of user systems using communication interface.

A processor executes instructions as known to those skilled in the art. The instructions may be carried out by a special purpose computer, logic circuits, or hardware circuits. Thus, processor may be implemented in hardware, firmware, or any combination of these methods and/or in combination with software. The term “execution” is the process of running an application or the carrying out of the operation called for by an instruction. The instructions may be written using one or more programming language, scripting language, assembly language, etc. Processor executes an instruction, meaning that it performs/controls the operations called for by that instruction. Processor operably couples with output interface, with input interface, with computer-readable medium, and with communication interface to receive, to send, and to process information. Processor may retrieve a set of instructions from a permanent memory device and copy the instructions in an executable form to a temporary memory device that is generally some form of RAM. User device may include a plurality of processors that use the same or a different processing technology.

Output interface provides an interface for outputting information for review by CSR and/or by customer. For example, output interface may include an interface to display, speaker, printer etc. . . . . Display may be a thin film transistor display, a light emitting diode display, a liquid crystal display, or any of a variety of different displays known to those skilled in the art. Speaker may be any of a variety of speakers as known to those skilled in the art. Printer may be any of a variety of printers as known to those skilled in the art. CSR device may have one or more output interfaces that use the same or a different interface technology. Display, speaker, and/or printer further may be accessible by a user device through communication interface.

One aspect of the present invention relates to the use and optimization (in customer facing organizations) of “social media based targeting” to direct offers in particular for “easy” targets i.e. existing customers who have voluntarily contacted a company for some form of service. This type of interaction arises millions of times a day in the customer care industry (for example e.g., product technical support, financial services, investment brokers, insurance companies, ticket agents, etc.)

While an inbound contact (e.g., phone call, email, chat, or online form submission) from a customer concerning an issue under his/her product warranty contract on the face of it does not seem to be a prime marketing opportunity, the upside and value cannot be overlooked. Companies in the warranty servicing industry have traditionally not looked to use this customer contact for marketing purposes exposing a missed opportunity of considerable significance. Quite literally, millions of calls of this type are made to warranty companies in North America each year.

In the context of a voluntary inbound contact from a customer, and a satisfactory resolution of their problem, there now exists a customer with the selected brand in the front of their mind and in a positive frame of mind given resolution of his/her issue (original purpose of communication). This is an ideal marketing opportunity for a permission based offer, in the nature of “returning the favor”. The challenge has previously been: how does one make this offer with limited information and without significantly increasing the service time of the Customer Service Representative (CSR), or requiring an upgrade to the decision-making ability of the CSR. This is a difficult situation to manage as typically there are multiple possible offers for the CSR to choose from, and it must be done dynamically, in real time while the customer is engaged in the communication. Management also wants to track the effectiveness of the program. Each of these issues is solved by the method and system of the present invention.

Herein, the CSR is preferably supported with a system which will provide the CSR with a specific dynamically updated dialogue to use with that customer tailored to the particular circumstances. The method of the present invention preferably combines data from the corporate Customer Relations Management (CRM) database, contextual data on the purpose of the originating call (for example product and warranty issue), and data derived in real time from the customer's internet content cues to select a specific offer for that customer, and the dialog for the CSR to use to make the offer. The offer will be transmitted to the customer via their preferred communication option (e.g., email, a post on a social media site, or text message). The computer then tracks the results of the offers and presents summaries to management.

Examples of how the method, using real time social media information along with CRM information, may be applied to generate an offer include:
1. an insurance customer has purchased a new bike. If their existing coverage is inadequate then offer additional coverage to cover their bike.
2. an insurance customer has checked into Foursquare in a number of worldwide cities. If the customer doesn't already have travel insurance then offer it.
3. an existing bank customer is looking to buy a house. If the customer hasn't already been preapproved for their mortgage, the bank could pre-emptively send them a preapproval offer.
4. a handset protection customer has just provided a mobile phone to her daughter. If the mother didn't add handset protection then offer a special family coverage
5. a telco customer is preparing to move to a new city. If the customer hasn't applied to transfer their services, the telco could offer them a discounted transfer package via direct mail to ensure they don't switch providers during the move.
6. a cable customer has just had a new baby. If the customer isn't subscribed to baby channels, the cable company could offer them a special family friendly upgrade.
7. an investment broker customer has just had a new baby. If the customer hasn't set up an education savings program, the broker could proactively send them information about such programs.
8. a ticket purchasers has started to “like” a new band on Facebook. If the band comes to town then proactively notify them of available tickets.

In a modified form, the method of the invention can be used not specifically to market to a customer, but to simply build customer engagement and loyalty to a brand through the use of a “personal emotional connection” (PEC). This concept provides a much wider field of application for the invention. The PEC can be built using any piece of personal information about the customer, such as the customer's location or personal interests as determined by their social media interactions. In this case, the method incorporates the personal information (such as the weather, or results of the local sports team) to build an engagement dialog for the CSR to use to engage with the customer in a friendly conversation, making a positive emotional connection with the customer.

Examples of how the method, using real time social media information along with CRM information, may be applied to generate an engagement dialog include:
1. Weather reports indicate that it has rained for 6 consecutive days in the customer's city. Within the method of the present invention, such data creates a directed, prompt for the CSR, an “engagement dialog” for example: “The weather in [insert city] sure has been tough for you guys lately. Are you surviving the rain?”
2. Via social media information along with CRM information, it is determined that the customer has a young child and that it is a sunny day in the customer's city. Within the method of the present invention, such data creates a directed, prompt for the CSR, an engagement dialog, for example: “Do you have any kids at home enjoying the sunshine today?”
3. Via social media information along with CRM information, it is determined that the customer works for a technology company and that a new technology product was just announced today. Within the method of the present invention, such data creates a directed, prompt for the CSR, an engagement dialog, for example: “Have you been following today's announcement about the new [insert product]?”
4. Via social media information, it is determined that the customer follows a particular band on Twitter and that the band will be in the customer's area in 30 days. Within the method of the present invention, such data creates a directed, prompt for the CSR, an engagement dialog, for example: “You're living in [insert city], I can see that [insert band] is coming to town next month . . . are you a fan?”

In a preferred form, the system and method of the present invention generates a dynamic offer or engagement dialog for a Customer Service Representative (CSR) of a Customer Care Company to deliver during an inbound customer contact. The program selects the offer or engagement dialog by constructing in real time a complete customer profile using CRM data, marketing history, product data, and harvested online social and demographic data, and then matching the profile to an optimal marketing campaign based on the company's business rules. The accepted offer is transmitted to the customer via their preferred communication option (e.g., email, Facebook, Twitter, text message).

In January 2012, Forrester Research Inc. published a report: “The Forrester Wave Cross-Channel Campaign Management, Q1 2012”. This report identified 11 large companies who offer “cross-channel campaign management” (CCCM) software applications. These systems include all aspects of marketing campaign design, development, execution, and assessment. The report noted a trend to shifting marketing budgets to digital media with more emphasis on “bi-directional and cross-channel dialogue between customers and businesses”. The applications offered by these companies are intended to support all types of businesses. The report also noted the emergence of smaller CCCM companies specializing in specific business segments (e.g. HMOs). Under a heading “A Mature Market Grapples with Seismic Change” the core message of the report is delivered as follows: “ . . . we look at how vendors support traditional campaign management capabilities—program planning, cross-channel decision management, optimization, and analytics—as well as meet the emerging needs of marketers in cross-channel execution, social campaigns, and real-time contextual triggers.”

The considerable investment required to purchase, install, and use any of the major CCCM product offerings discussed in the report would be worthwhile for companies whose brand recognition is key to their success. The specific situation where an existing customer has voluntarily contacted the company is rich in marketing potential but has typically been ignored. One non-limiting example of this is in the area of product service or warranty calls. For example, if an extended warranty is involved, a customer who buys the extended warranty on a product bought at Retailer XYZ, typically isn't even aware that the warranty is actually managed by another third party warranty company contracted with Retailer XYZ. The warranty service companies, operating behind the scenes, don't have the marketing pressures that face most retailers, wholesalers, and manufacturers. Most of these warranty service companies, lacking a marketing focus and bound by regulatory restrictions, never conceived of persons contacting them about warranty service issues as marketing opportunities. With millions of incoming warranty service calls a year in North America, the marketing potential of these interactions is substantial.

The invention provides a system and method that can, in one embodiment, tap into the inbound warranty communications and exploit them for their marketing potential, or simply to build brand loyalty. This increases the value of the service the warranty service companies provides its corporate customers, and leads to increased revenues for both the corporate customers and the warranty service companies. Furthermore, what can work for the indirect customer care provider such as the warranty service companies, can also work for virtually any company providing direct customer care such as a financial services company, retail services, retail products, etc.

In the context of the Forrester report, the present invention focuses on the emerging needs of marketers in cross-channel execution, social campaigns, and real-time contextual triggers.

Given that there is an unexploited marketing opportunity for a Customer Care Provider (CCP) either directly or on behalf of its clients (such as in warranty service), the CCP faces three significant challenges in marketing effectively to service customers.

The first challenge is what exactly to market. In today's global economy, customers are overwhelmed with advertising and solicitations of all sorts whether they be traditional newspaper and television ads, or telemarketing and direct mail campaigns, or web ads invading all forms of social media (web pages, Google searches, Facebook, Twitter, YouTube, etc.). Unless an inducement is carefully tailored to the individual customer and the particular circumstances of the moment, it is likely to be rejected and even cause a negative reaction with the customer. So if a CCP is going to market to its customers, it had better do so with a suite of carefully tuned offers which can be matched optimally to each customer. In addition, if the CCP is highly regulated (like the warranty industry) ensuring the accuracy of the offer and communication is even more essential.

The second challenge to the CCPs is to design suitable options to offer the customers and to track the success of the various offers. This has to be easy to do for the company's marketing departments, and responsive to a dynamic environment. A method and system to assist in the construction of offers which is sophisticated but easy to use, and responsive in real time is fundamental. The method and system include back-end analytics to collect, process, give definable and defendable weight to the pieces of data and to create the customized offer.

The third challenge is to operationalize this new marketing campaign using the existing CCP customer service representatives (CSRs). Retraining the CSRs or upgrading the general capability level of the CSRs is not feasible given the large population of CSRs currently employed. Nor do the CCPs want to significantly lengthen the average service time of a CSR customer interaction, as this would increase operating costs. The answer is a real time computer assist for the CSR which will provide them with a specific tailored dialogue to use with each customer.

If instead of, or in addition to, a traditional marketing campaign, the objective of the CCP is to achieve a personal emotional connection (PEC) with a customer, there exists a similar challenge to design a suitable means of engagement, make it simple for the existing cadre of CSRs to handle, and analyze the results. An alternative form of the invention, the method and system use real time information relevant to the customer (such as their location) which is collected/gathered through the Internet, to construct an intelligent machine-generated personalized dialog for the CSR to engage the customer. The success of the engagement (wherein data on success and lead generation is automatically tracked) is measured and used to improve the methodology used to generate the dialogs, and also to assess the proficiency of the CSRs. Such a loop provides 1) feedback; 2) monitors CSR success and 3) creates opportunities to improve metrics and data used to generate the personalized dialogue.

The present invention addresses and overcomes each of the aforementioned challenges and provides a computer-implementable method for selection and delivery of a customized offer to a consumer by a live customer service representative (CSR) in communication with said consumer comprising:

a) upon a first communication from the consumer to the CSR, enabling the CSR to acquire from a first computer system at least one identifying feature of said consumer;
b) using the at least one identifying feature to generate automatically, without CSR involvement, a search of the internet, via a second computer system, to acquire at least one current, real time internet content cue relating to said consumer, said real time internet content cue being collected while the CSR maintains engagement with the consumer;
c) processing, via the second computer system, the at least one identifying feature and the at least one current, real time internet content cue to generate a consumer profile for said consumer;
d) analyzing the consumer profile to create customized offer for the consumer; and
e) prompting the CSR to provide the customized offer to the consumer.

Preferably, at least one of the first computer system and the second computer system automatically and dynamically offers to the CSR a consumer communications script. Preferably, the consumer communications script is updated by the first computer system based on one or more of 1) responses given by consumer to questions posed by CSR; 2) internet content cues; 3) the identifying feature; 4) the consumer profile; and 5) reaction of the consumer to the customized offer.

Preferably, the communication is selected from the group consisting of phone, email, SMS (text), Blackberry messenger (BBM), social media outlets, and other online means (including Skype, iChat, etc. . . . ). Preferably, the first computer system acquires at least one identifying feature of said consumer from a remote server with which it is in communication. Preferably, the first computer system and the second computer system are the same. Preferably, the CSR communication and prompts are enabled by an application operating on a CSR computer system. Preferably, the generation of a customized offer for the consumer is enabled by a campaign management application on the second computer system. Preferably, the second computer system is that of a customer care provider. Preferably, the second computer system is that of a remote hosted website.

Preferably, the real time internet content cue is acquired from a social media outlet. Preferably, the real time internet content cue is acquired from a social media outlet selected from the group consisting of collaborative projects, social networking sites, media sharing sites, review/opinion sharing sites, Internet forums, blogs, content communities, virtual game worlds, and virtual communities. Preferably, the real time internet content cue is acquired from a social media outlet selected from the group consisting of Wikipedia, Myspace, Twitter, Facebook, HootSuite, Flickr, YouTube, Pinterest, Google+, Epinions, WikiAnswers, weblogs, social blogs, and microblogs. Preferably, for a consumer, a new second profile is created upon the initiation of a second communication with the CSR, said second profile dynamically reflecting alterations in the consumer's internet content cues between the first communication and said second communication. Preferably, at least one identifying feature of said consumer is selected from the group consisting of any single or combination of said consumer's name, address, phone number, email address, social media outlet usernames, a unique identifier previously supplied to the consumer, a password, identification of a recent item purchased, age, gender, location, demographic data, employment, birthday, social insurance number, and family details.

Preferably, the consumer initiates a communication with the CSR for the purpose of discussing a warranty in relation to a product. Preferably, the customized offer is a discount coupon. Preferably, the customized offer is a discount coupon which is actionable by the consumer upon he/she posting a pre-agreed promotional statement on at least one of consumer's social media outlets.

In another aspect, the present invention provides a machine implemented system that selects and delivers a customized offer to a consumer via a live customer service representative (CSR) in communication with said consumer comprising the following machine executable components:
a device for live communication between the CSR and the consumer;
a first processor to acquire at least one identifying feature of said consumer;
a second processor to search the internet and to acquire at least one current, real time internet content cue relating to said consumer, to generate a consumer profile for said consumer based upon the at least one real time internet content cue and the at least one identifying feature and creating a customized offer for the consumer based at least in part on the consumer profile;
   an interface for the CSR to add data relating to the consumer and to view the consumer profile and the customized offer.

Preferably, the first processor and the second processor include a means to communicate with the CSR to automatically and dynamically offer to the CSR a consumer communications script, viewable on the interface. Preferably, the consumer communications script is updated by one of first processor and the second processor based on one or more of 1) responses given by consumer to questions posed by CSR; 2) internet content cues; 3) the identifying feature; 4) the consumer profile; and 5) reaction of the consumer to the customized offer. Preferably, the communication is selected from the group consisting of phone, email, SMS (text), Blackberry messenger (BBM), social media outlets, and other online means (including Skype, iChat, etc. . . . ).

Preferably, the first processor and the second processor are the same. Preferably, the system includes a CSR computing system, engaged with the interface, said CSR computing system comprising an application which directs the CSR with dynamically updated language, script and prompts to engage the consumer. Preferably, the system comprises a campaign management application on the second processor. Preferably, the real time internet content cue is acquired from a social media outlet. Preferably, the real time internet content cue is acquired from a social media outlet selected from the group consisting of collaborative projects, social networking sites, media sharing sites, review/opinion sharing sites, Internet forums, blogs, content communities, virtual game worlds, and virtual communities. Preferably, the real time internet content cue is acquired from a social media outlet selected from the group consisting of Wikipedia, Myspace, Twitter, Facebook, HootSuite, Flickr, YouTube, Pinterest, Google+, Epinions, WikiAnswers, weblogs, social blogs, and microblogs.

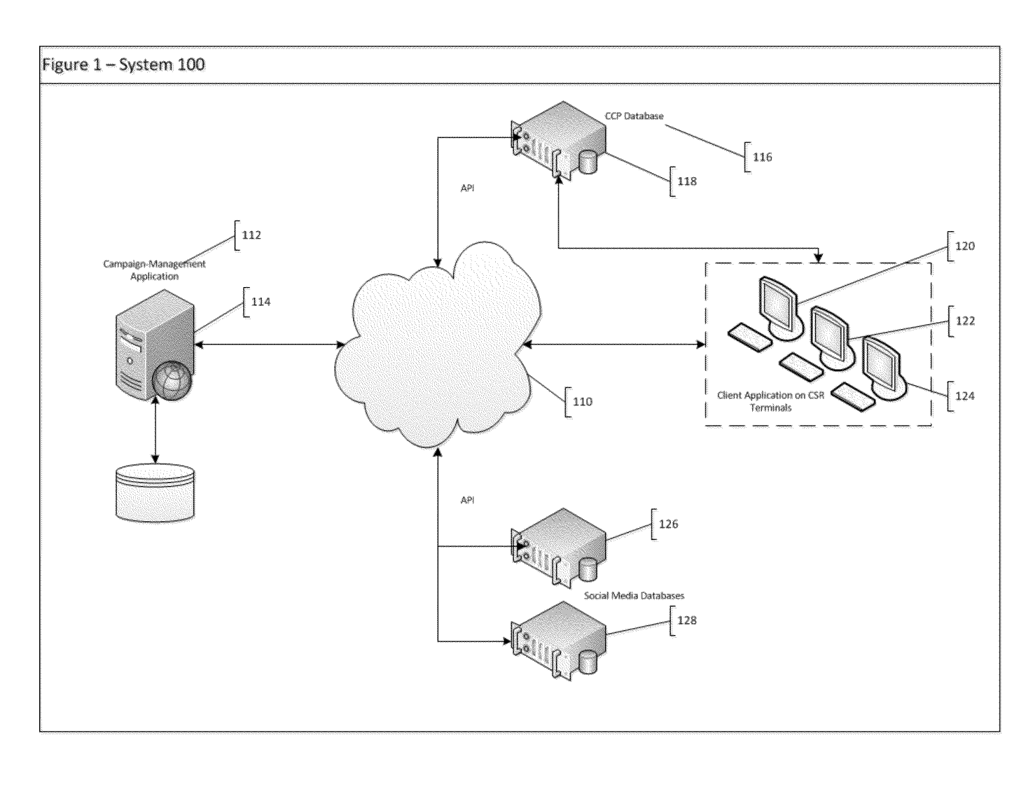

Turning to FIG. 1, there is provided an exemplary customized offer generating system (or simply system “100”) wherein through network 110, a campaign management application 112 on campaign management processor 114 communicates via CCP database 116 on CCP processor 118 with a plurality of CSR terminals 120, 122, and 124. At each of such terminals, a CSR communicates (via varying communication modes as described herein) with a consumer. Social media application processing interfaces (APIs) are shown as 126 and 128. By way of a campaign management application 112 on campaign management processor 114, internet content cues relating to the consumer are mined from APIs 126 and 128 and processed at either processor 118 and/or campaign management processor 114. “Process” is understood to have the broadest possible meaning and includes gathering the internet content cues in real time, weighting/valuing the internet content cues and combining such cues with other information acquired on said consumer in order to yield a customized offer.

Via FIG. 1, one can appreciate the interconnection of campaign management processor 114, CCP processor and social media APIs in information gathering and processing to enable a CSR of a Customer Care Company to offer an inducement to an inbound customer contact. The figure shows the primary systems involved in the invention. The campaign-management application is the central driver of the invention. The campaign-management application sends and receives customer data with the CCP database via an API. The campaign-management application also acquires data via API from social media sites. CSRs have local terminals which interact with the CCP's database to send and receive customer information. In addition, the CSR terminals run the Client Application which is used to send and receive information from the campaign-management application.

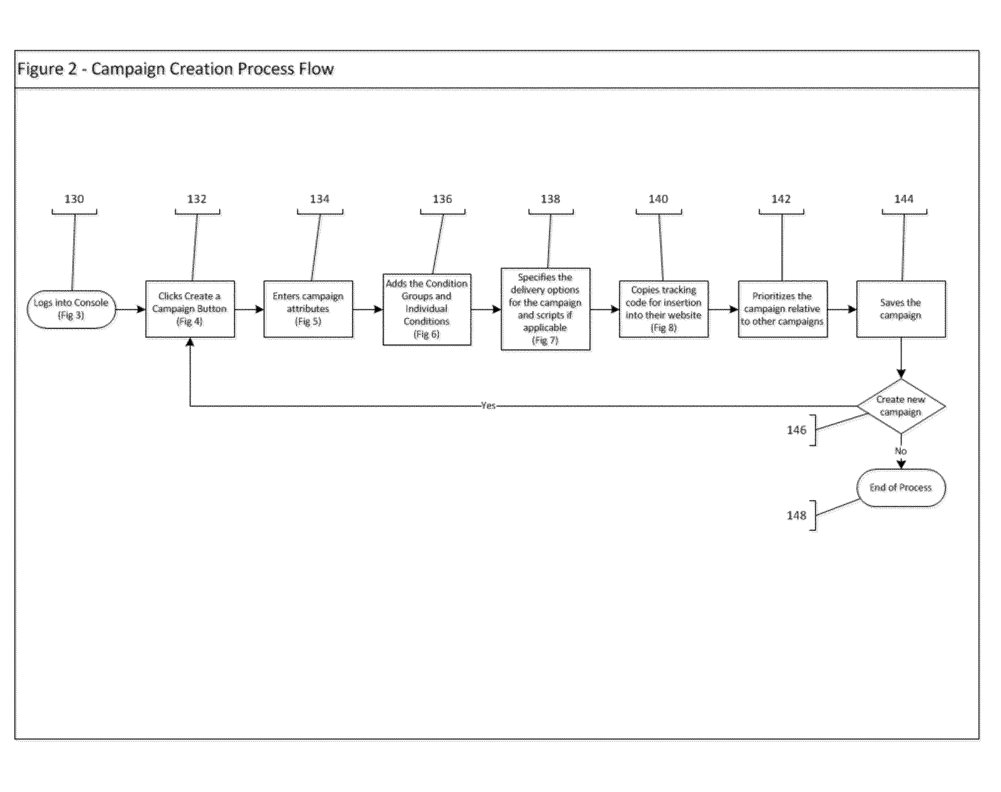

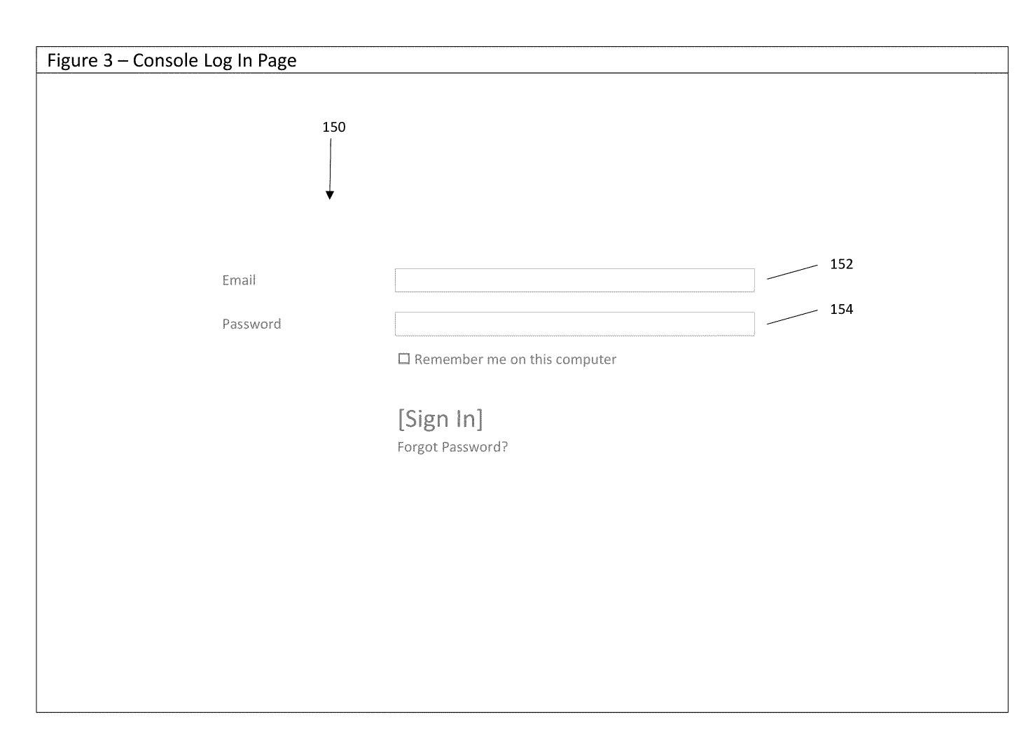

FIG. 2 is a flow chart of the present invention depicting the process of creating a new campaign. The boxes in FIG. 2 align with the user interface wireframes presented in FIGS. 3 through 8.

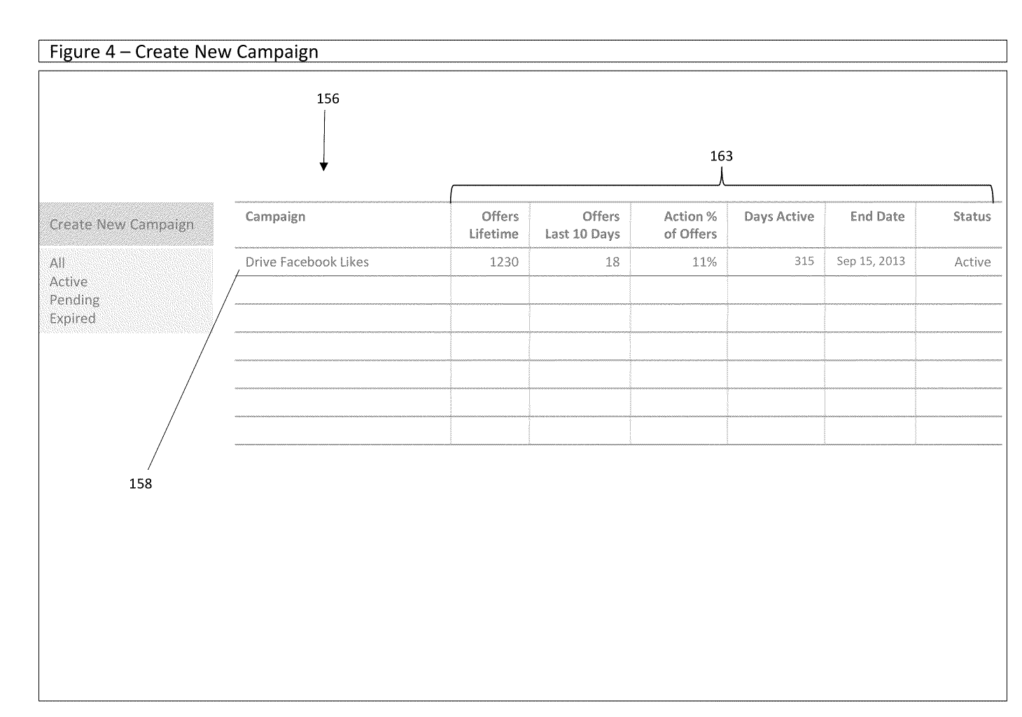

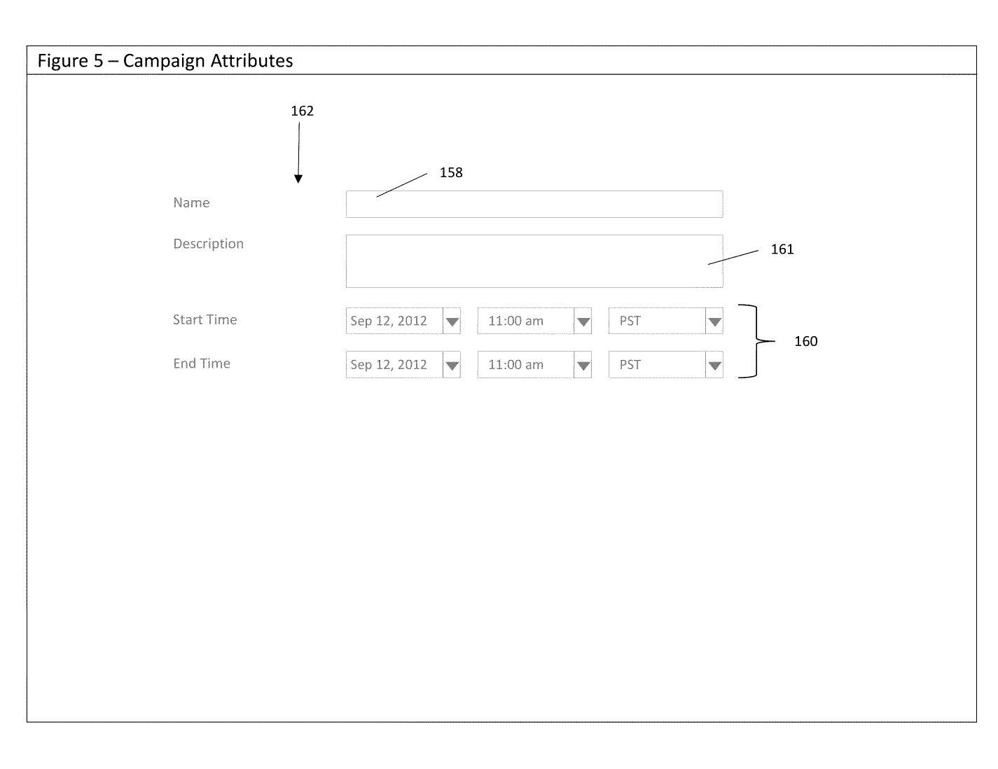

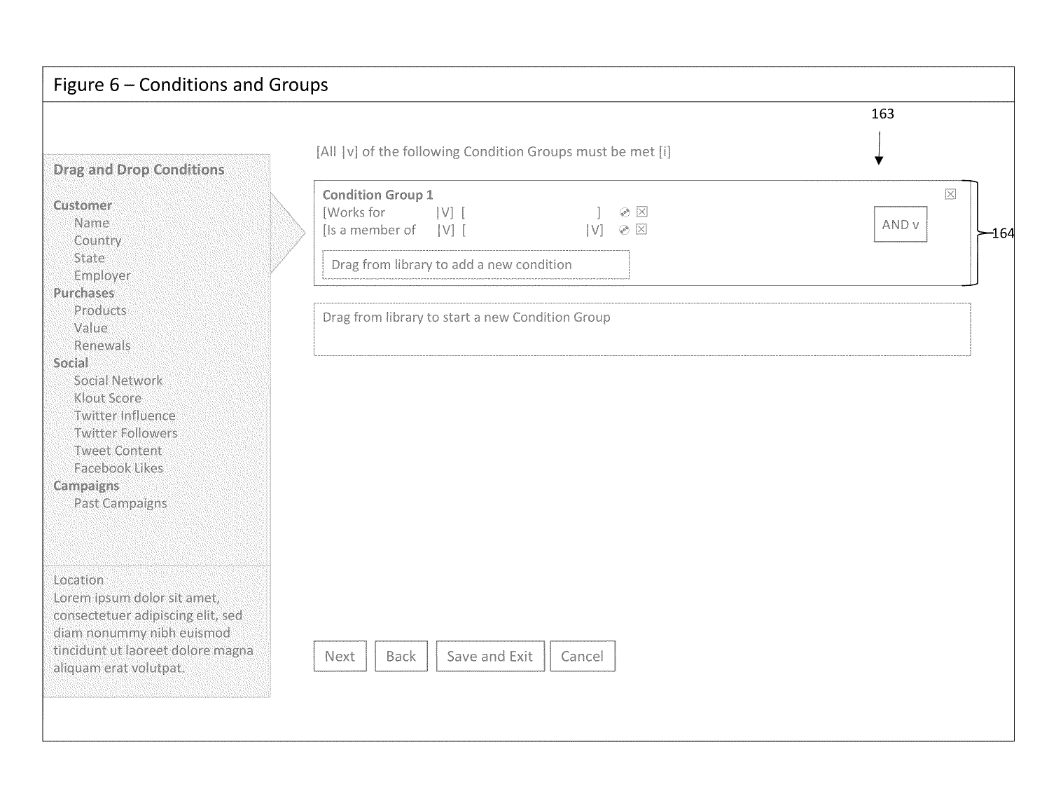

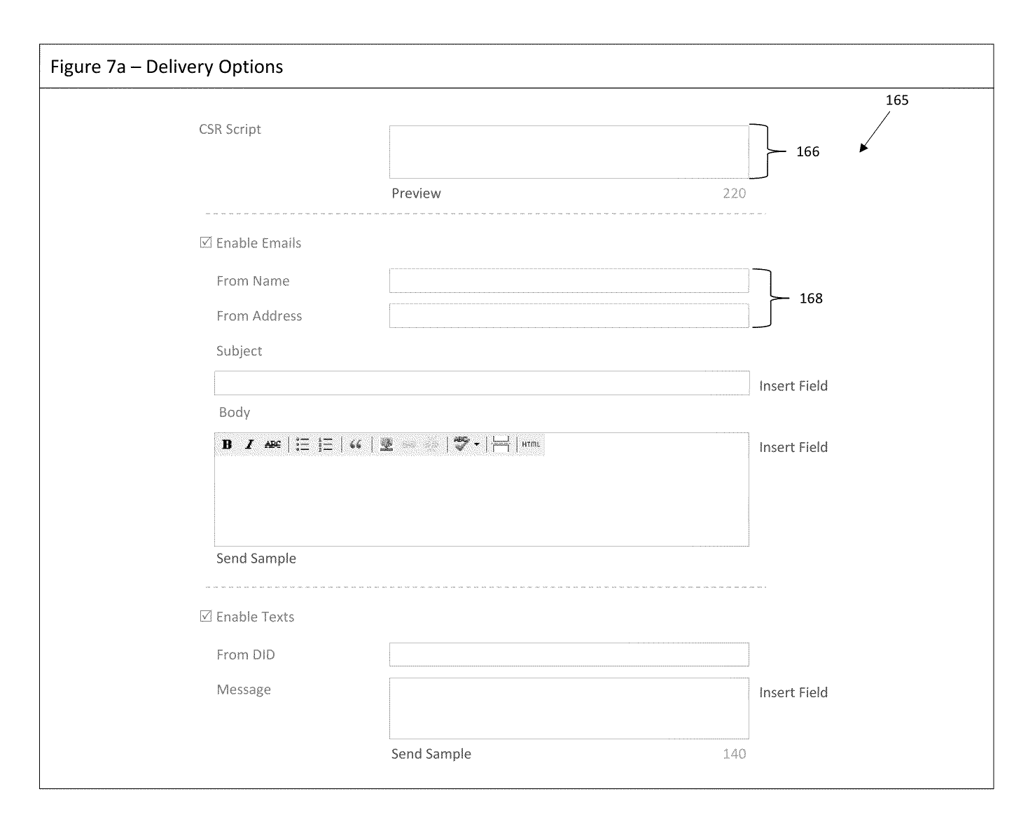

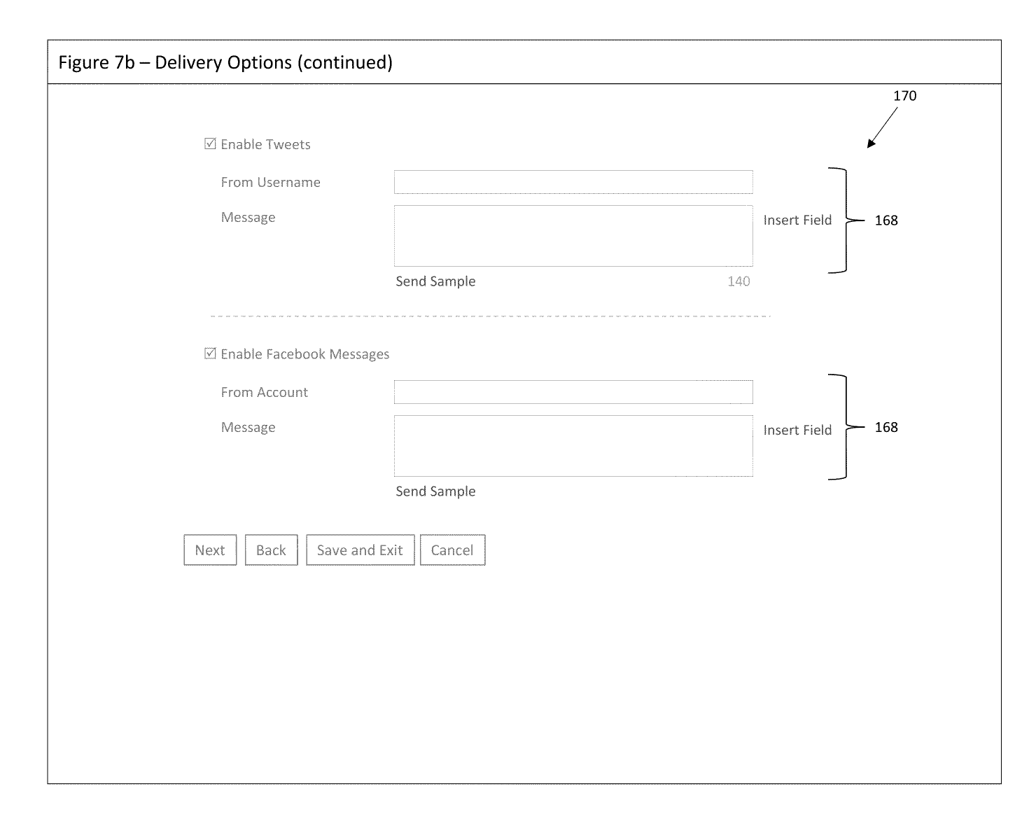

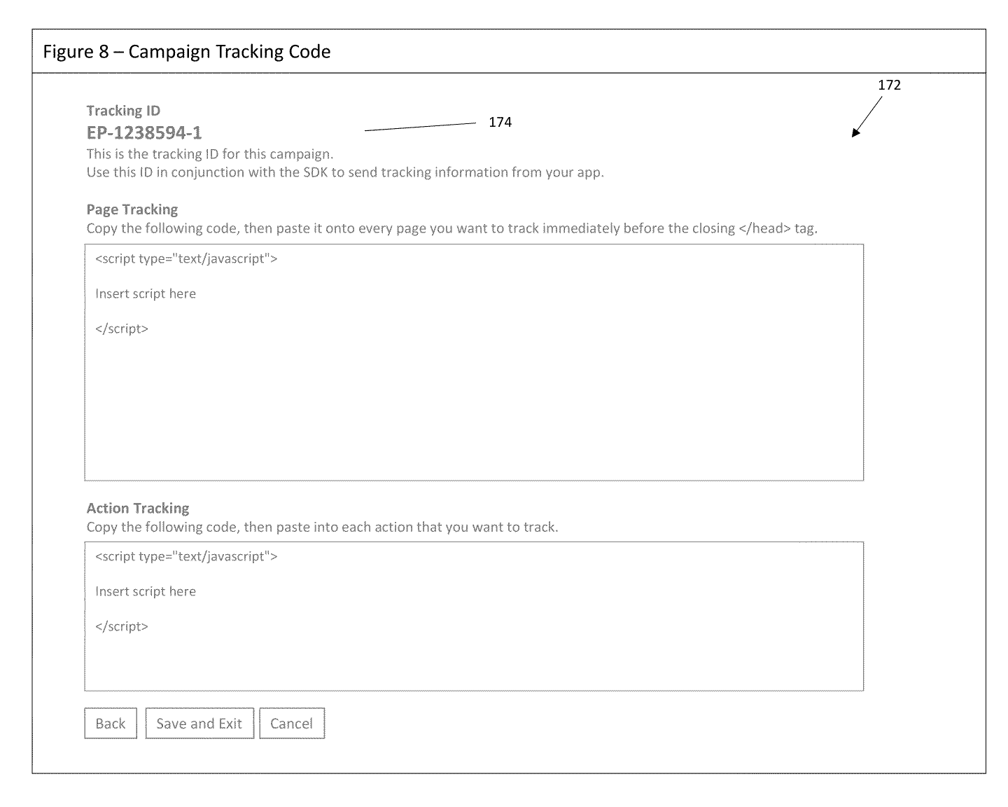

More specifically, in FIG. 2, it is depicted that CSR logs into his/her console at 130 (illustrated further in FIG. 3), clicks to create a campaign at 132 (illustrated further in FIG. 4), enters attributes at 134 (illustrated further in FIG. 5), adds the condition groups and individual conditions at 136 (illustrated further in FIG. 6), specifies delivery options for the campaign and delivery scripts if available/applicable at 138 (illustrated further in FIGS. 7a and 7b), copies tracking code for insertion into website at 140 (illustrated further in FIG. 8), prioritizes the campaign relative to other campaigns at 142, saves the campaign at 144 and in feedback loop makes decision whether to commence the creation of new campaign at 146—if yes feedback loop to 132 and if no, end process at 148.

To begin the process, the user accesses the console via an interface page 150 through a web browser using his/her unique username 152 and confidential password 154 (FIG. 3). The user then clicks a button to create a new campaign (FIG. 4). On interface pages 156 and 162, the user provides basic attributes for the campaign such as a campaign name 158, description 161, inventory of offers 163 and the dates and times 160 which the campaign should be active (FIGS. 4 and 5). At interface 163, the user selects which conditions 164 need to be met in order to trigger a campaign. Conditions can be grouped to enable more complex campaign determination (FIG. 6). At interfaces 165 and 170, the user then specifies how the campaign can be delivered to the customer (e.g., email, social media posting, text message, etc.) 168 along with the relevant CSR scripts 166 and delivery content (FIGS. 7a and 7b). At interface 172, the user is then presented with tracking codes 174 which can be embedded into the outcome pages to track the success of the campaign (FIG. 8). The user then sets a priority for the campaign to determine its presentation relevant to other campaigns in the system. Finally the user saves the campaign and has the option of repeating the process with another campaign.

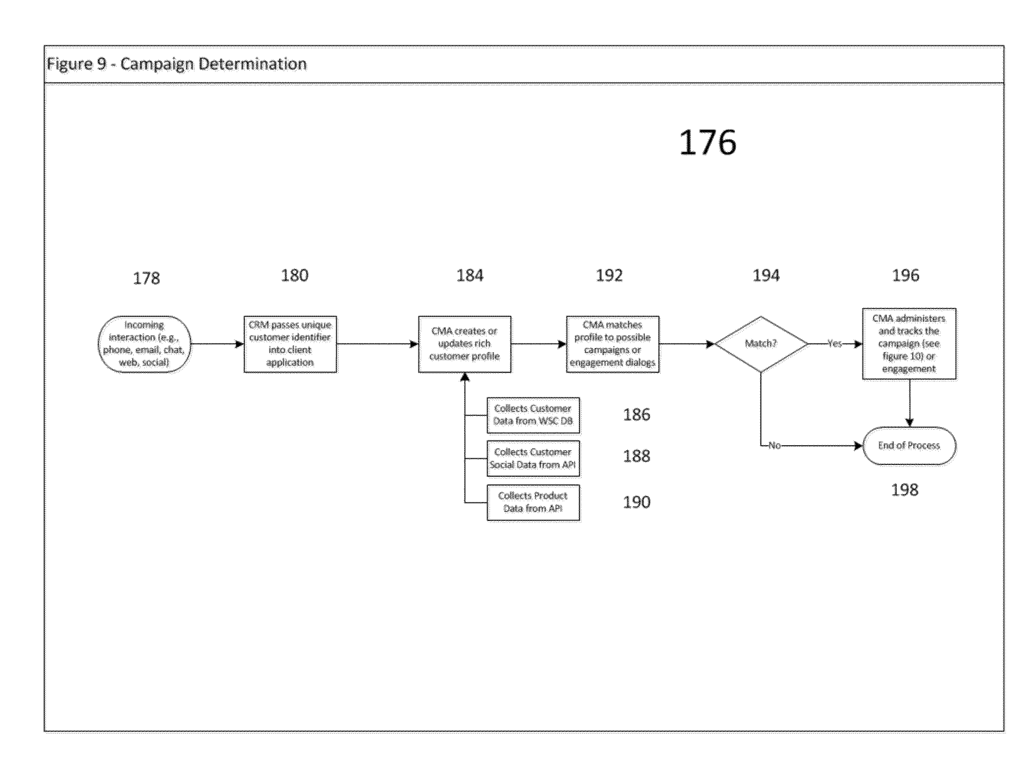

FIG. 9 is a flow chart 176 of the campaign determination/management application selecting a campaign to provide for a particular customer. Once these opportunities are identified, the method and system of the invention create a rich customer profile which includes collecting information from the CCP's database, social media sites and other possible sources of data such as a product database. The invention then matches the profile to the pre-established campaigns.

Specifically, at step 178 there is incoming interaction between CSR and customer. This can be via any means (for example, phone, email, chat, web or via a multitude of other social media). Automatically, CRM passes any customer identifiers to Client Application at 180 (via for example, harvesting of existing CRM data and harvesting of social media data). Discourse occurs between CSR and customer.

At 184, CMA aggregates data to create rich customer profile. In particular, Customer Data is collected from WSC DB at 186, Customer Social Data is collected from API at 188 and Product Data is collected from API at 190.

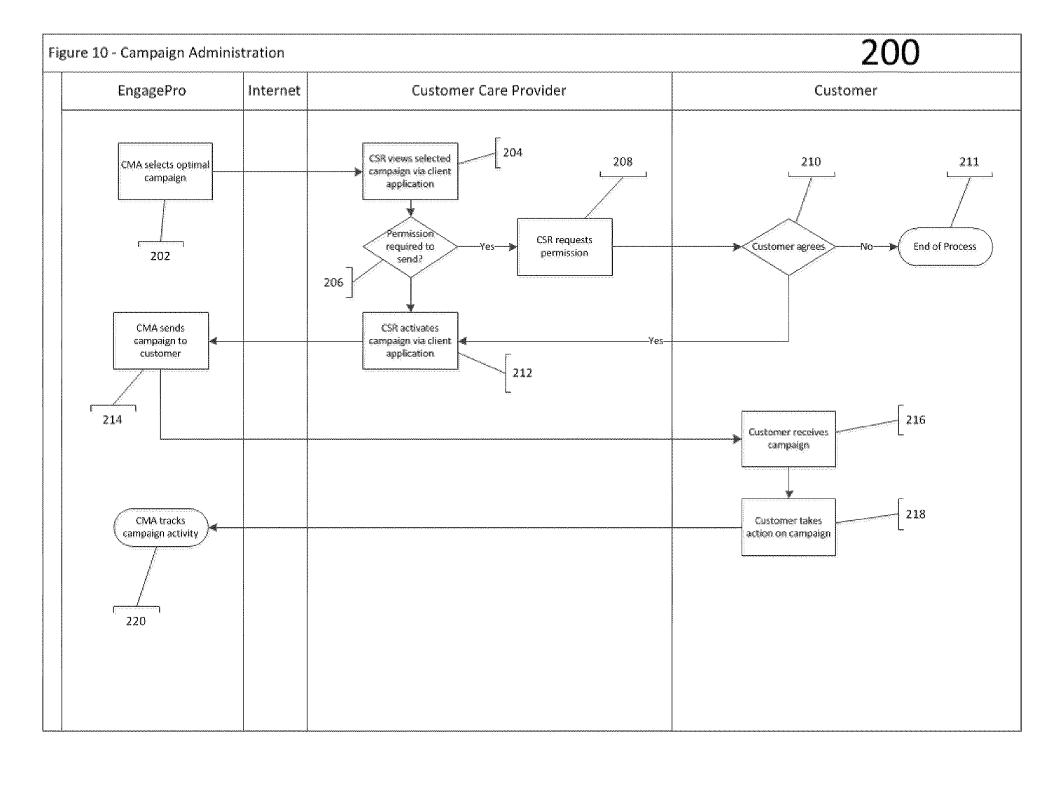

At 192, CMA matches the profile (so created or enhanced with each customer engagement) to possible campaigns or engagement dialogs. If match found at 194, campaign offered to customer and CMA administers and tracks the campaign at 196 (see FIG. 10) and process ends at 198. If no, process ends at 198 and no campaign is offered to the customer.

FIG. 10 is a flow chart at 200 showing how a campaign in administered to a customer by the CCP's CCRs. Once the optimal campaign is selected by CMA at 202 (see details in FIG. 9), the CSR views the campaign via the client application running on their local terminal at 204. If applicable at 206, the CSR requests the customer's permission at 208 to send the campaign. If no, process ends at 211. If permission is provided at 210, the CSR activates the campaign at 212 via the client application. The CMA then sends the campaign to the customer at 214, customer receives campaign at 216 where he/she can take action on the desired goals at 218. The CMA tracks at 220 the outcome of the customer's actions.

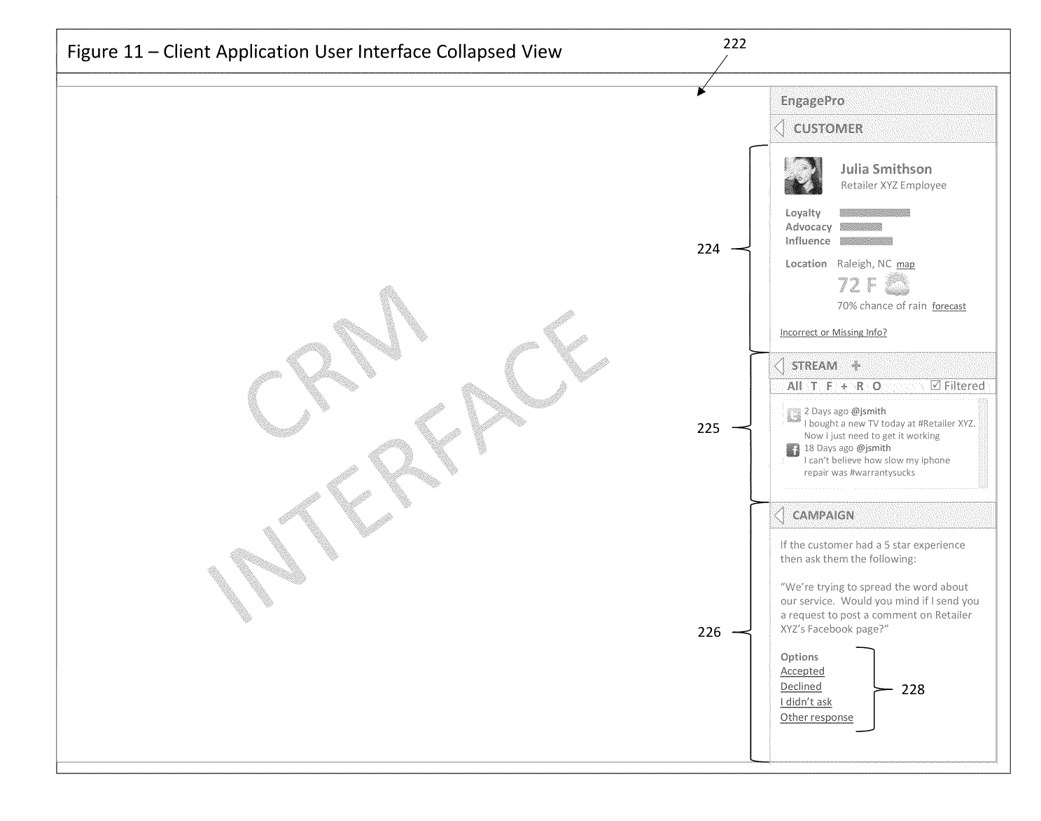

FIG. 11 shows a collapsed view of the client application user interface 222 which a CSR accesses via their local terminal. The client application resides alongside the CSR's existing CRM system. In the collapsed state, the CSR has access to basic information 224 such as the customers influence, loyalty and advocacy scores as created by the invention. In addition, the CSR can see a listing (Stream) of social media postings made by the customer at 225. Finally, at the bottom of the client application, the CSR can view the select campaign 228 including the script 226 and any required steps to administer the campaign.

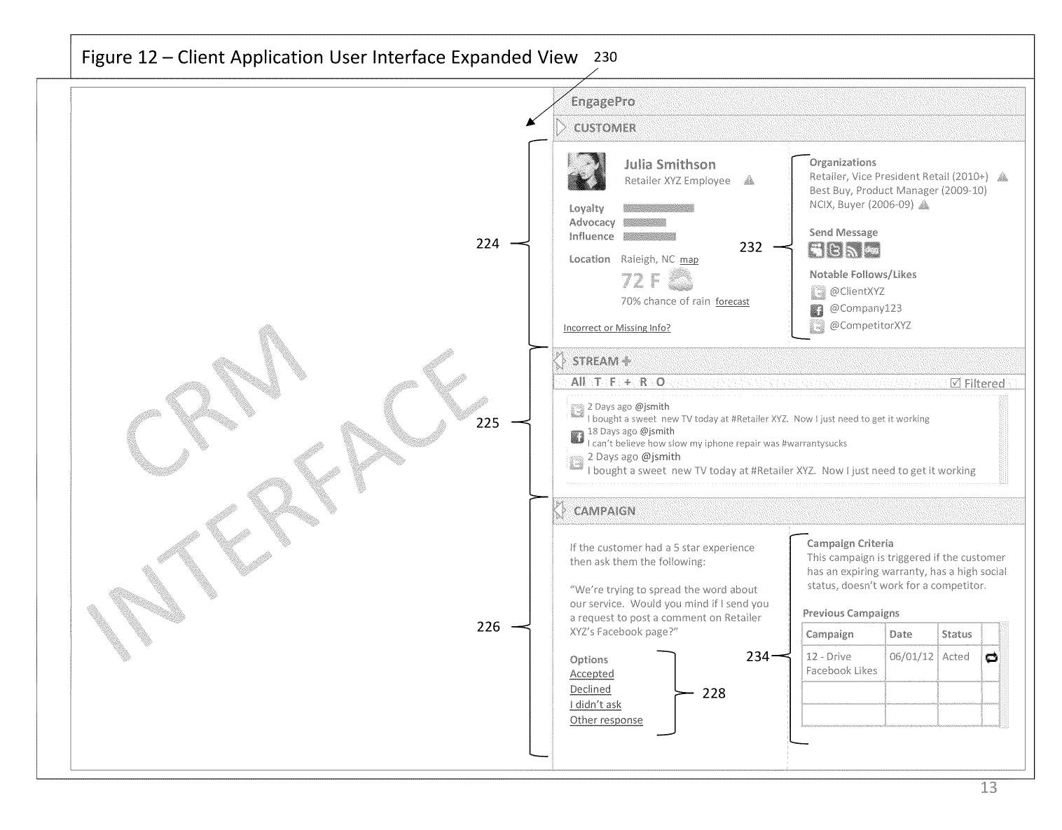

FIG. 12 shows an expanded view of the client application user interface 230. In the expanded view, the CSR has access to the same information as in the collapsed view as well as additional details such as the customer's employer, social media sites and notable friends and followers 232. In addition, the CSR can see historical campaigns 234 that have been administered including the ability to repeat a previous campaign.

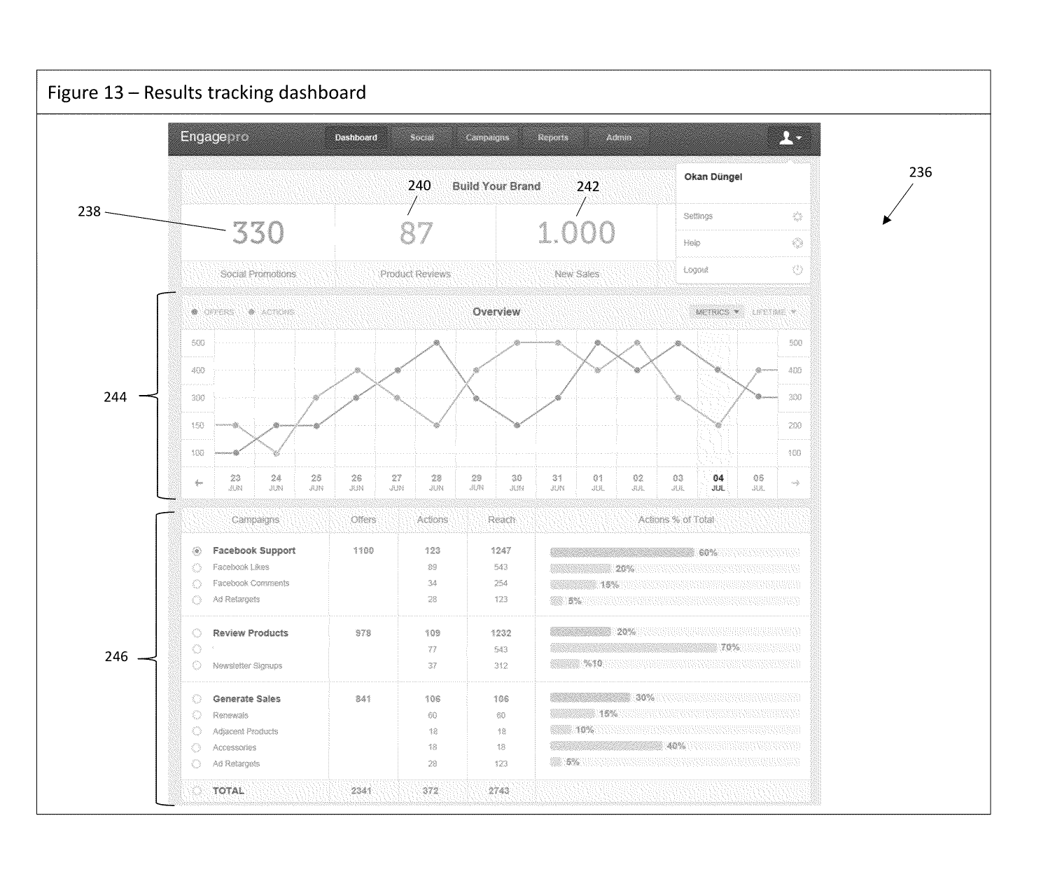

FIG. 13 is a representation of a dashboard 236 for tracking the results of the customized offers and engagement dialogs with numerics on social promotions 238, product reviews at 240 and new sales at 242. A graphic overview is provided at 244 and extended analytics at 246.

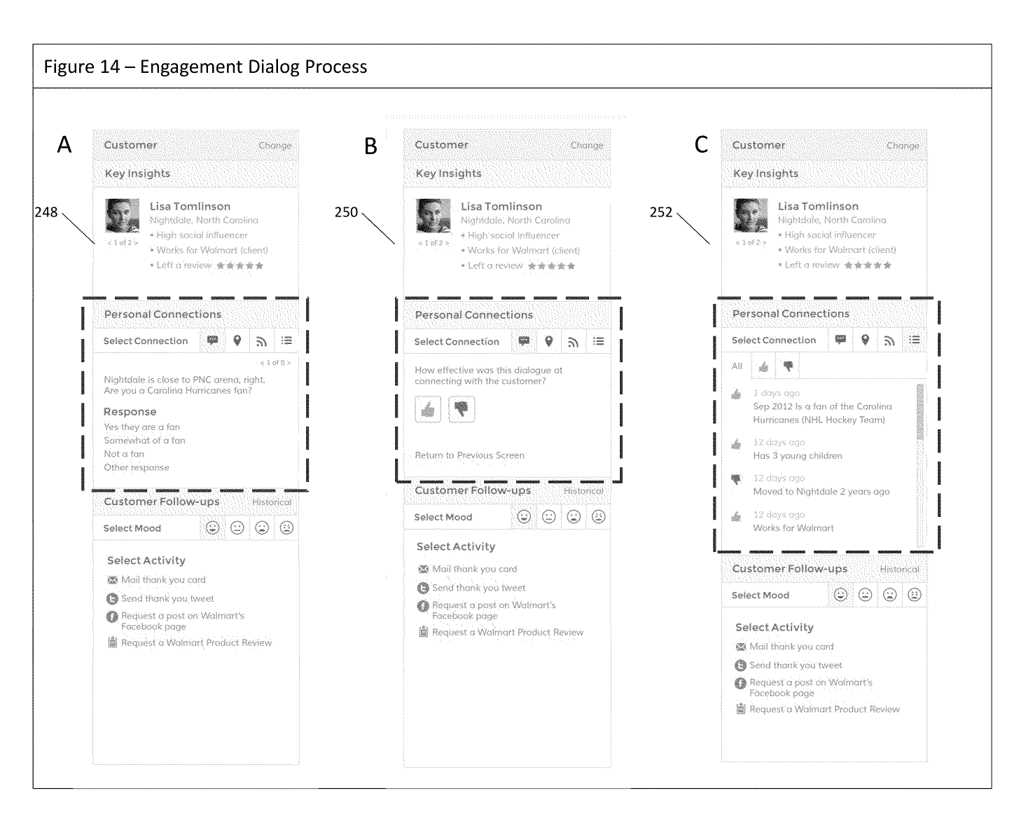

FIG. 14 shows three states of the engagement dialog process (A) dialog presentation (248) (B) engagement tracking (250) (C) historical learnings (252).

### Inbound Customer Telephone Calls

The most common means for a customer to make a service inquiry is to phone a CCP Call Center. The phone call is handled by a customer service representative (CSR) trained to handle such inquiries. The use of the invention in the context of an inbound phone call will be explained first.

The invention provides a system and method that is a unique and effective answer to each of the challenges faced by the CCP industry to start effective marketing with inbound service callers. The invention is implemented in a number of related computer programs using the worldwide web metaphor (screens presented as web pages and implemented in HTML and CSS, interacting with server databases under control of processing logic implemented in the programming language). The programs and related databases are installed on the CCP's computer site or on a commercial site selling hosting services. The CSR interacts with the service customer in voice mode over the telephone, and transmits the agreed offers to the customer over the internet or to a mobile device of the customer.

The first challenge is to create a unique offer for the profile of the inbound caller. Whereas existing software in this realm use CRM data (e.g. purchase and interaction history), and possibly demographic data (age, sex, location), the invention extends these traditional data sources by gathering social media data in real time and including it in its optimizing algorithm. Thus if the caller is determined to have a large number of social media (e.g., Twitter) followers, the optimal offer may be to provide them with a dollars off coupon in exchange for posting a tweet about Retailer XYZ's services. Or a caller who is registered with LinkedIn is likely to be in a higher economic strata, so the offer can be tailored with this in mind.

The way this part of the invention works is that one part of the overall invention software, called the campaign-management application, is installed on a computer server that is hosted on the CCP's computer site or on a commercial site selling hosting services.

The second part of the invention software called the client application is installed resident on each CSRs terminal. The client application functions like a web browser sending data back and forth with the campaign-management server via the WWW. In an alternate implementation, the client application can be accessed through an existing web browser on each CSR's terminal.

The CSRs terminal also has access to a CCP CRM application which accesses data from a CCP database in order to assist customers calling about whatever service issue. This information is provided by the customer when they first bought the product and typically includes: name, address, phone number, email address, a unique customer identifier, date of purchase, item purchased, and any warranty details. If a warranty is involved, if the customer holds a warranty on other products, this too will be noted in the CCP database.

In addition to a terminal, the CSR is also equipped with a telephone headset. When the CSR answers an inbound telephone call from a service customer, they obtain identifying information from the customer so that they can access the customer's record in the CCP database. They key this identifier (either a product/warranty/service serial number or a customer identifier like a phone number) into the CCP CRM application, and it retrieves information about the customer and product/warranty/service and displays this on the CSR's screen. The CSR is now in a position to discuss and resolve the service inquiry being made by the customer.

At this point the CSR has correctly identified the customer and where applicable any product, service or coverage details in the CCP CRM application. The CCP CRM application either automatically or via CSR intervention, passes a unique customer identifier to the client application. The client application then automatically sends this information to the campaign-management application which immediately does two things.

First, it sends the unique customer id to the CCP database via an Application Programming Interface (API). Based on the id, relevant information about the customer (e.g., name, address, phone number) and the customer's purchasing history (e.g., items purchased, prices, dates, warranties purchased, etc.) is pulled from the CCP database and transmitted back to the campaign management application for use in the optimizing algorithm.

The second thing the invention software does with the customer id is invoke one or more web API calls to obtain up-to-the-minute information about the customer available in the public social media—Facebook, Twitter, LinkedIn, etc. This social data is returned to the invention software.

All of this data gathering (customer and, where applicable, any product service or coverage details from the CCP database and social data from the internet search) is happening in the invention software while the CSR is on the phone with the customer discussing the service issue. The invention posts a summary of the customer's profile on the client application visible on the CSR's screen.

Other marketing software typically takes demographic data and purchasing history about a customer to determine if they match a profile for a marketing campaign. The invention, by also including social media data, not only enables more sophisticated choices about an optimal marketing campaign, but the nature of the offers can be extended to exploit the social influence of the customer. For example, a customer who calls about a warranty and receives a satisfying resolution, and is determined by the invention to be a normal user of social media may be asked to post a product or service review on the retailer's website. On the other hand if the invention determines that the customer has high social media influence (e.g., a large number of friends on Facebook or other social media site), it may request that the customer post a comment on a particular Facebook corporate page to promote the CCP or the retailer. In other words, the consumer is enticed to use his/her social media presence to promote a product or service and will, in turn, be rewarded for that.

The invention now adds a script to the client application on the CSR's screen. The script is for the CSR to use for marketing to the customer in the final phase of the phone call. This script embeds the unique offer selected for this customer. The script is read word-for-word by the CSR to the customer. Depending on the customer's response, the invention software continues to guide the CSR through a dialogue which hopefully ends with the customer accepting the offer.

The invention software that assembles all of the profile data (particularly integrating real time social media data), matches it to the single best offer to make to the customer, and then presents the CSR with a literal script for interacting with the customer is unique in both the scale of the undertaking, as well as in the particular set of coding that implements the algorithm.

The second challenge is to create an easy to use, but flexible and sophisticated, method for creating and updating a suite of offers to match against various customer profiles. This challenge is resolved by the campaign-management application.

This part of the campaign-management application is called the console and is accessed via a web browser and is restricted to qualified users. These users are identified by the CCP and their access is password controlled. When a qualified user signs into the console, they are presented with a series of screens which lead them through the process of building an offer. The invention method takes each of the relevant pieces of data about the customer which is used in the first part of the invention (e.g., demographics, sales history, social media profile, etc.), and allows the user to set a specified value or range of values for each data type so that collectively all the data types create a set of conditions which if matched in a customer profile will result in this specific offer being made. Each offer will have a unique identifier for tracking purposes.

The invention software also allows the marketing department to choose what offer it wishes to make (e.g., dollars off coupon, favorable review on a company website, posting to Facebook wall, etc.) for each set of conditions. This is essentially qualitative data, entered by the user as text. The invention software then leads the marketing user through a process to create the dialogue for the CSR to use when making the offer. This dialogue is typically a decision tree with several branches depending on the responses of the customer.

A unique aspect of this approach is that the dialogue can be tailored to suit the corporate style (formal, casual, hip, etc.) of the selling company, or alternative versions of the dialogue can rendered in different styles based on e.g., the age of the customer, whether they have a high social media presence, or whatever.

The final major component of this second part of the invention system is the results analysis and management reporting. Because the phone conversation between the CSR and the service customer is structured by the invention software, high quality data is available for analysis of the success of the offers made, or not made. And because social media is used for many of the offers, web software can be used to track the result. For example if the customer had agreed to post a review to the company website, the invention will monitor the website to determine if the review shows up.

The invention software captures all this information in a database on the web server, and provides to qualified users a scoreboard (dashboard) reflecting the results. This analysis has all the data about the caller (demographics, social profile, purchase history), knows who the CSR is, knows the offers made, and knows whether the offers are accepted or rejected. This is a very rich collection of information relevant to management of both the original seller (comparison of results based on offer and customer profile), and of the CCP (comparison of results by CSR).

The invention method includes a set of screens designed to provide scorecard data to management of both the CCP and any associated parties. The data is presented over the web and is invoked by qualified users. Different reports are generated for different classes of users. The raw data can also be exported to the CCP or associated parties for their own data analysis and management reporting.

One of the factors used in determining the optimal offer is customer location. Besides the obvious use of location to select an optimum offer (e.g. a coupon for an air conditioner if the customer is in Phoenix, or a coupon for a dehumidifier if the customer is in Seattle), the location factor also enables the marketing company to test a new campaign in a limited area before rolling it out more widely.

A further feature of the system and method of value to the selling company is the ability to use the invention to do randomized trials of alternative marketing campaigns. The software can randomly choose between alternative offers, and the subsequent take-up of the offers measured to determine which offers are more attractive to the customers.

The CCCM systems discussed by Forrester (above) all involve some way to create marketing campaigns. It is only the most advanced of these products that contemplate use of real-time contextual triggers like this invention, and this invention is unique in including social media data as part of the triggering algorithm. Even if other company's software provides similar computer-assisted means to build marketing campaigns, the algorithm used by the invention is unique in how it implements the concept.

The third challenge is to make this invention easy and efficient to use by the CSRs so that the additional marketing effort does not add significantly to operating costs of the CCP. The CCP must achieve more value from implementing the system and method than the cost of amortizing the software cost, plus the cost of adding to the CSR's service time with each customer. The increase in value comes from increased sales or goodwill from the additional marketing effort.

The customized dialogue created for the CSR by the client application answers this challenge. As noted above, one part of the invention method is integrated with the CCP CRM application which supports the CSR in interacting with the service customers over the phone. When the CSR answers the phone call of the service customer, he obtains the unique id of the customer and enters this into the CCP CRM application, the invention software is triggered as explained above. During the course of the phone call the CSR conducts with the customer about the service problem, the invention software populates a client application with relevant customer profile information.

The invention software also does its offer matching and immediately returns to the client application a description of the offer and a specific word-for-word dialogue to use with the customer to make the offer. The CSR follows the dialogue script with the customer over the phone. Depending on the responses the customer gives, the CSR clicks choices on his computer screen, and the dialogue follows appropriate branches as pre-determined when the offers were constructed at part two of the invention. Thus a customer may decline an initial offer but if they fit the proper parameters, a backup offer may be made, again using a computer-generated script.

Once the CSR enters on the screen that an offer has been accepted, the invention software then prompts the CSR to enter which mode of delivery the customer prefers for the offer. This may be an email, a social media (e.g., Facebook, Twitter, etc.) posting, or a text message. The invention software then immediately transmits the offer to the customer by the preferred means. The customer may be able to confirm receipt of the offer before ending the phone call with the CSR.

By using a tailored computer-generated dialogue, the CSR does not need additional training or upgrading to become an effective marketer. Also by controlling the dialogue, the service time used by the CSR is kept to an efficient level. Then by allowing the customer to select their preferred mode of delivery of the offer, the customer should end the call feeling highly satisfied with the outcome. They have had their original service call resolved, they have been given an inducement specifically tailored to their profile, they haven't had to wait for the offer to arrive, and they have been professionally handled throughout the phone conversation. It should be noted that if the customer was not satisfied with the resolution of the original service call, the invention software may forgo making any marketing offer lest the customer become even more dissatisfied.

The computer-generated dialogue for the CSRs is highly innovative in that it has been developed by marketing specialists to fit specific customer parameters, yet can be effectively delivered by the CCP's normal CSR staff without additional training. It also controls the length of the marketing effort, and provides quantitative data to be used for management information about the success of the marketing programs.

### Email Option

Customers with service inquiries may also email the CCP rather than phone in to a call center. The invention can be used to market to such inquiries as follows.

A CSR of a CCP receives an emailed enquiry. They extract from the email either the product/warranty/service number or a unique customer id which they enter into the CCP customer service application. This is the same application as explained above for phone calls. If the system does not already have the customer's email address, that too is entered. The CSR continues to process the inquiry in the same manner as if the invention was not in place, up to the point of preparing a response email to the customer, but not yet sending it.

At this point the CSR has correctly identified the customer and product/warranty/service in the CCP CRM application. The CCP CRM application either automatically or via CSR intervention, passes a unique identifier to the client application. The client application then automatically sends this information to the campaign-management application which gathers the same rich mix of customer data as described above: demographics, purchase history, and most particularly information about social media presence/influence. The invention then selects an optimum offer to make this particular customer. The software generates email text outlining the offer, and returns it to the CSR screen via the client application. The CSR then cuts and pastes this text into the regular email he has prepared in response to the customer's inquiry, and sends the email to the customer. The invention software makes a record in its database of the offer and the relevant data about the customer.

For an inbound email communication, there is not a different method for the CCP to create the suite of offers and attendant conditions used in the optimizing process of the invention. The same offers work for email as for phone. However, the company marketers will have to create the email text similar to the phone dialogue which goes along with each offer. Likewise the analysis of the success of the offers and the opportunities for test marketing are identical for emailed offers as for phone offers.

There is no additional CSR training or upgrading needed to handle email offers, since the invention produces the text of the offer for the CSR to include in the inquiry response email. There is no additional data that the invention requires from the CSR compared to what the CSR enters into the CCP inquiry support system.

### Social Media Alternative

Customers with service issues may also use Twitter or other social media sites to register their inquiries to the CCP rather than phone in to a call center. The invention can be used to market to such inquiries as follows.

A CSR of a CCP receives a social media enquiry (e.g., a tweet). They extract from the enquiry either the product/warranty/service number or a unique customer id which they enter into the CCP CRM application. This is the same application as explained above for phone calls. If the inquiry service system does not already have the customer's social media ID (e.g., Twitter handle), that too is entered. The CSR continues to process the inquiry in the same manner as if the invention was not in place.

At this point the CSR has correctly identified the customer and product/warranty/service in the CCP CRM application. The CCP CRM application either automatically or via CSR intervention, passes a unique identifier to the client application. The client application then automatically sends this information to the campaign-management application which gathers the same rich mix of customer data as described above: demographics, purchase history, and most particularly information about social media presence/influence. The invention then selects an optimum offer to make this particular customer. If the CSR approves the offer, the software generates a tweet outlining the offer, and using the Twitter handle entered earlier, automatically tweets the customer without further intervention required by the CSR. The invention software makes a record in its database of the offer and the relevant data about the customer.

There is not a different process for the CCP to create the suite of offers and attendant conditions used in the optimizing process of the invention. The same offers work for tweets as for phone. However, the company marketers' will have to create the tweet text similar to the phone dialogue which goes along with each offer. Likewise the analysis of the success of the offers and the opportunities for test marketing are identical for social media offers as for phone offers.

There is no additional CSR training or upgrading needed to handle social media offers, since the invention produces and sends the offer automatically without involving the CSR. The only additional data that the invention requires from the CSR compared to what the CSR enters into the CCP customer service system is the social media ID of the customer.

### Online Submission Alternative

Customers with service issues may post their inquiries via an online website or mobile application rather than phone in to a call center. The invention can be used to market to such inquiries as follows.

A CSR of a CCP receives an online submission for a service issue. They extract from the inquiry either the product/warranty/service number or a unique customer id which they enter into the CCP CRM application. This is the same application as explained above for phone calls. If the customer service system does not already have the customer's email address that too is entered. The CSR continues to process the inquiry in the same manner as if the invention was not in place.

At this point the CSR has correctly identified the customer and product/warranty/service in the CCP CRM application. The CCP CRM application either automatically or via CSR intervention, passes a unique identifier to the client application. The client application then automatically sends this information to the campaign-management application which gathers the same rich mix of customer data as described above: demographics, purchase history, and most particularly information about social media presence/influence. The invention then selects an optimum offer to make this particular customer. If the CSR approves the offer, the software generates a response which the CSR can provide to the customer via online submission or other communication channel. The invention software makes a record in its database of the offer and the relevant data about the customer.

There is not a different process for the CCP to create the suite of offers and attendant conditions used in the optimizing process of the invention. The same offers work for online or mobile submission as for phone. However, the company marketers' will have to create the text similar to the phone dialogue which goes along with each offer. Likewise the analysis of the success of the offers and the opportunities for test marketing are identical for offers in response to postings as for phone offers.

There is no additional CSR training or upgrading needed to handle website posting offers, since the invention produces the text of the offer for the CSR to include in the inquiry response. There is no additional data that the invention requires from the CSR compared to what the CSR enters into the CCP customer service system.

### In Person Option

Customers with service inquiries may also visit a CCP rather than phone in to a call center. The invention can be used to market to such inquiries as follows.

A CSR of a CCP receives a visit from a customer at a service location. They request from the customer either the product/warranty/service number or a unique customer id which they enter into the CCP customer service application. This is the same application as explained above for phone calls.

At this point the CSR has correctly identified the customer and product/warranty/service in the CCP CRM application. The CCP CRM application either automatically or via CSR intervention, passes a unique identifier to the client application. The client application then automatically sends this information to the campaign-management application which gathers the same rich mix of customer data as described above: demographics, purchase history, and most particularly information about social media presence/influence. The invention then selects an optimum offer to make this particular customer. The software generates a script and returns it to the CSR screen via the client application. The script is read word-for-word by the CSR to the customer. Depending on the customer's response, the invention software continues to guide the CSR through a dialogue which hopefully ends with the customer accepting the offer. The invention software makes a record in its database of the offer and the relevant data about the customer.

For the customer visit alternative, there is not a different method for the CCP to create the suite of offers and attendant conditions used in the optimizing process of the invention. The same offers work for in person as for phone. Likewise the analysis of the success of the offers and the opportunities for test marketing are identical for in person offers as for phone offers.

There is no additional CSR training or upgrading needed to handle in person offers, since the invention produces the script for the CSR to read to the customer. There is no additional data that the invention requires from the CSR compared to what the CSR enters into the CCP inquiry support system.

### Relationship Building

The above sections focus on the use of the method and system of the invention for direct marketing purposes. In the alternative, the method and system of the invention can also be used simply to build a stronger customer relationship with a brand, which is called a “personal emotional connection” (PEC) in current business jargon. A PEC can also be used to calm a customer who might be otherwise be upset or defensive when calling for support.

For this aspect of the invention. the method and system still employs and accesses the same sales history and social media profile data as described above, but focuses on at least one piece of personal customer information to generate a dialog for the CSR to use simply to build a relationship with the customer i.e. goodwill. For example, if the social media data/metrics reveal that the customer is a dog lover, then a dialog is automatically generated around the subject of dogs. In many situations, the customer's location will be a primary piece of personal information used to build the dialog. Location is universally available, and, unless drilled down to a specific house, has few to no privacy implications.

The method and system of the present invention use an Internet API to gather information about the customer's location such as weather, current news stories, or events involving the local sports team or celebrities. Using this information, a script to initiate a dialog with the customer is created and provided to the CSR. For example, if the weather has been rainy for several days, the script might open with “The weather in [city] sure has been tough for you guys lately. Are you surviving the rain?” Another example making use of social media would have the method determine that the customer follows a particular band on Twitter. The method also determines that the band will be in the customer's area next month. So the CSR is presented with a script “You're living in [city], I can see that [band] is coming to town next month . . . are you a fan?” The net result is that, via automated mining for social media and other data, a brief personal dialog between the CSR and customer is generated so as to create a positive emotional connection between the customer and the brand represented by the CSR.

In its fullest realization, the method would collect, analyze, store and update personal data about a particular CSR (e.g., technical knowledge, age, interests, marital/children status, etc.) and use this information to compare and contrast like data acquired about the customer to identify “common ground” and to assist in determining how best to engage with the customer. For example, if the CSR has little knowledge of sports, then a sports dialog shouldn't be utilized. For example, if the CSR is an avid traveler, then appropriate tailored dialogues can automatically be created for domains of overlap or commonality with any customer.

These scripts are carefully tailored to use phraseology which will make the customer feel comfortable. Using computer-generated scripts makes it easy for the CSR, and enables the company to control the messaging.

As shown in FIG. 14, the CSR records on the computer the customer's response to the dialog and how effective the CSR feels the message was in achieving a PEC. This information is used to better tailor the message for subsequent customer calls (not only from that customer but also from other customers), and to determine which are the most effective lines of engagement.

In preferred aspects, the present invention provides:
1. Use of a social media profile in determining the optimum marketing campaign choice for each customer, or establishment of a PEC with a customer
2. Use of social media criteria to establish marketing campaigns, or PECs
3. Integration with extant customer service systems of the CCPs
4. Automatic generation of dialogue to be used by CSR
5. Ease of use for test marketing including randomized processes
6. Coverage of all forms of inbound communications—phone, email, social media, online submission
7. Suitable for e.g., extended warranty market which is unique in that it is highly regulated and operates behind the scenes
8. the concepts are extendable to other industries and across various marketing channels

The systems and methods described herein rely on a variety of computer systems, networks and/or digital devices for operation. As will be appreciated by those skilled in the art, computing systems and web-based cross-platforms include non-transitory computer-readable storage media for tangibly storing computer readable instructions. In order to fully appreciate how the web-based cross-platform smart phone application creation and management system operates an understanding of suitable computing systems is useful. The web-based searching and data mining disclosed herein are enabled as a result of an application operable via a suitable computing system.

In one aspect, a computer system (or digital device), which may be understood as a logic apparatus adapted and configured to read instructions from media and/or network port, is connectable to a server and can have a fixed media. The computer system can also be connected to the Internet or an intranet. The system includes central processing unit (CPU), disk drives, optional input devices, such as a keyboard and/or mouse and optional monitor. Data communication can be achieved through, for example, communication medium to a server at a local or a remote location. The communication medium can include any suitable means of transmitting and/or receiving data. For example, the communication medium can be a network connection, a wireless connection or an Internet connection.

It is envisioned that data relating to the present disclosure can be transmitted over such networks or connections. The computer system can be adapted to communicate with a participant and/or a device used by a participant. The computer system is adaptable to communicate with other computers over the Internet, or with computers via a server. Each computing device (including mobile devices) includes an operating system (OS), which is software, that consists of software programs and data that runs on the devices, manages the device hardware resources, and provides common services for execution of various application software. The operating system enables an application program to run on the device.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

A user launches an app created by an app creator and downloaded to the user's mobile device to view digital content items and can connect to a front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website via an app at any time. The user may include a variety of different computing devices

FIG. 1 illustrates a system 100 that effectuates and/or facilitates mobile application delivery and reconfiguration to a plethora of disparate mobile devices. As illustrated system 100 can include server/application delivery platform 102 that can provide the ability to download an adaptable framework of the generic class mobile application onto the mobile device; to communicate with the mobile device, said communication directing the server to reconfigure at least one of content, presentation and function of the generic mobile application, therein creating a specific use of the generic class mobile application or reconfiguring one specific use application to another specific use application.

Application delivery platform, as illustrated, via network topology and/or cloud, can be in continuous and/or operative or sporadic and/or intermittent communication with a plurality of consumer devices and between campaign management ad CSR agents utilizing over the air (OTA) data interchange technologies and/or mechanisms. As will be appreciated by those of reasonable skill in the art, mobile devices as may be used in consumer communications can include a disparity of different, diverse and/or disparate portable devices including Tablet PC's, server class portable computing machines and/or databases, laptop computers, notebook computers, cell phones, smart phones, transportable handheld consumer appliances and/or instrumentation, portable industrial devices and/or components, personal digital assistants, multimedia Internet enabled phones, multimedia players, and the like.

Network topology and/or cloud can include any viable communication and/or broadcast technology, for example, wired and/or wireless modalities and/or technologies can be utilized to effectuate the claimed subject matter. Moreover, network topology and/or cloud can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Furthermore, as those skilled in the art will appreciate and understand various data communications protocols (e.g., TCP/IP, Ethernet, Asynchronous Transfer Mode (ATM), Fiber Distributed Data Interface (FDDI), Fibre Channel, Fast Ethernet, Gigabit Ethernet, Wi-Fi, Token Ring, Frame Relay, etc.) can be utilized to implement suitable data communications.

Additionally application delivery server/platform may include a provisioning component that, based at least in part on input received from a portal component, can automatically configure and/or provision the various disparate mobile devices with appropriate applications.

It is to be appreciated that a store can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 206 of the subject systems and methods is intended to comprise, without being limited to, these and any other suitable types of memory. In addition, it is to be appreciated that the store can be a server, a database, a hard drive, and the like.

### Server Modules, Components, and Logic

Certain embodiments are described herein as including logic or a number of modules, components or mechanisms. A module, logic, component or mechanism (hereinafter collectively referred to as a “module”) may be a tangible unit capable of performing certain operations and is configured or arranged in a certain manner. In example embodiments, one or more computer systems (e.g. server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, mobile phones, personal digital assistants, smart phones, personal music players (like iPod) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such as those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts. As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

The following examples provide additional embodiments of the disclosed technology:
1. A computer-implementable method for selection and delivery of a customized consumer offer or engagement dialog by a live customer service representative (CSR) in communication with said consumer comprising:
a) upon a first communication from the consumer to the CSR, enabling the CSR to acquire from a first computer system at least one identifying feature of said consumer;
b) using the at least one identifying feature to generate automatically, without CSR involvement, a search of the internet, via a second computer system, to acquire at least one current, real time internet content cue relating to said consumer, said real time internet content cue being collected while the CSR maintains engagement with the consumer;
c) processing, via the second computer system, the at least one identifying feature and the at least one current, real time internet content cue to generate a consumer profile for said consumer;
d) analyzing the consumer profile to create customized consumer offer or engagement dialog; and
e) prompting the CSR to provide the customized offer or engagement dialog to the consumer.
2. The method of example 1 wherein at least one of the first computer system and the second computer system automatically and dynamically offers to the CSR a consumer communications script.
3. The method of example 2 wherein the consumer communications script is updated by the first computer system based on one or more of 1) responses given by consumer to questions posed by CSR; 2) internet content cues; 3) the identifying feature; 4) the consumer profile; and 5) reaction of the consumer to the customized offer or engagement dialog.
4. The method of example 1 wherein the communication is selected from the group consisting of phone, email, SMS (text), Blackberry messenger (BBM), social media outlets, and other online means (including Skype, iChat, etc. . . . ).
5. The method of example 1 wherein the first computer system acquires the at least one identifying feature of said consumer from a remote server with which it is in communication.
6. The method of example 1 wherein the first computer system and the second computer system are the same.
7. The method of example 1 wherein the CSR communication and prompts are enabled by an application operating on a CSR computer system.
8. The method of example 1 wherein the generation of a customized consumer offer or engagement dialog is enabled by a campaign management application on the second computer system.
9. The method of example 1 wherein the second computer system is that of a customer care provider.
10. The method of example 1 wherein the second computer system is that of a remote hosted website.
11. The method of example 1 wherein the real time internet content cue is acquired from a social media outlet.
12. The method of example 1 wherein the real time internet content cue is acquired from a social media outlet selected from the group consisting of collaborative projects, social networking sites, media sharing sites, review/opinion sharing sites, Internet forums, blogs, content communities, virtual game worlds, and virtual communities.
13. The method of example 1 wherein the real time internet content cue is acquired from a social media outlet selected from the group consisting of Wikipedia, MySpace, Twitter, Facebook, HootSuite, Flickr, YouTube, Pinterest, Google+, Epinions, WikiAnswers, weblogs, social blogs, and microblogs.
14. The method of example 1 wherein, for said consumer, a new second profile is created upon the initiation of a second communication with the CSR, said second profile dynamically reflecting alterations in the consumer's internet content cues between the first communication and said second communication.
15. The method of example 1 wherein the at least one identifying feature of said consumer is selected from the group consisting of any single or combination of said consumer's name, address, phone number, email address, social media outlet usernames, a unique identifier previously supplied to the consumer, a password, identification of a recent item purchased, age, gender, location, demographic data, employment, birthday, social insurance number, and family details.
16. The method of example 1 wherein the consumer initiates a communication with the CSR for the purpose of discussing a warranty in relation to a product.
17. The method of example 1 wherein the customized offer is a discount coupon.
18. The method of example 1 wherein the customized offer is a discount coupon which is actionable by the consumer upon he/she posting a pre-agreed promotional statement on at least one of consumer's social media outlets.
19. The method of example 1 wherein said method is encoded on non-transitory computer readable media and carries out as such.
20. A machine implemented system that selects and delivers a customized consumer offer or engagement dialog via a live customer service representative (CSR) in communication with said consumer comprising the following machine executable components:
a device for live communication between the CSR and the consumer;
a first processor to acquire at least one identifying feature of said consumer;
a second processor to search the Internet and to acquire at least one current, real time internet content cue relating to said consumer, to generate a consumer profile for said consumer based upon the at least one real time Internet content cue and the at least one identifying feature and creating a customized offer for the consumer based at least in part on the consumer profile;
an interface for the CSR to add data relating to the consumer and to view the consumer profile and the customized offer or engagement dialog.
21. The system of example 20 wherein the first processor and the second processor include a means to communicate with the CSR to automatically and dynamically offer to the CSR a consumer communications script, viewable on the interface.
22. The system of example 21 wherein the consumer communications script is updated by one of first processor and the second processor based on one or more of 1) responses given by consumer to questions posed by CSR; 2) internet content cues; 3) the identifying feature; 4) the consumer profile; and 5) reaction of the consumer to the customized offer or engagement dialog.
23. The system of example 20 wherein the communication is selected from the group consisting of phone, email, SMS (text), Blackberry messenger (BBM), social media outlets, and other online means (including Skype, iChat, etc. . . . ).
24. The system of example 20 wherein the first processor and the second processor are the same.
25. The system of example 20 including a CSR computing system, engaged with the interface, said CSR computing system comprising an application which directs the CSR with dynamically updated language, script and prompts to engage the consumer.
26. The system of example 20 comprising a campaign management application on the second processor.
27. The system of example 20 wherein the real time internet content cue is acquired from a social media outlet.
28. The system of example 20 wherein the real time internet content cue is acquired from a social media outlet selected from the group consisting of collaborative projects, social networking sites, media sharing sites, review/opinion sharing sites, Internet forums, blogs, content communities, virtual game worlds, and virtual communities.
29. The system of example 20 wherein the real time internet content cue is acquired from a social media outlet selected from the group consisting of Wikipedia, Myspace, Twitter, Facebook, HootSuite, Flickr, YouTube, Pinterest, Google+, Epinions, WikiAnswers, weblogs, social blogs, and microblogs.
30. A networked apparatus for use by a customer service representative (CSR) in live communication with a consumer comprising: a memory; a processor; a communicator; a display; and an data receiving module to receive a consumer profile and customized offer for said consumer, said profile generated by the analysis of at least one identifying feature and the at least one current, real time internet content cue related to said consumer, said display comprising an interface for the CSR to add data relating to the consumer and to view the consumer profile and the customized offer or engagement dialog.
31. The apparatus of example 30 wherein said interface automatically and dynamically offers to the CSR a consumer communications script.
32. Non-transitory, computer-readable storage media for tangibly storing thereon computer readable instructions for a method for the selection and delivery of a customized offer to a consumer by a live customer service representative (CSR) in communication with said consumer, said method comprising: a) upon a first communication from the consumer to the CSR, enabling the CSR to acquire from a first computer system at least one identifying feature of said consumer; b) using the at least one identifying feature to generate automatically, without CSR involvement, a search of the internet, via a second computer system, to acquire at least one current, real time internet content cue relating to said consumer, said real time internet content cue being collected while the CSR maintains engagement with the consumer; c) processing, via the second computer system, the at least one identifying feature and the at least one current, real time internet content cue to generate a consumer profile for said consumer; d) analyzing the consumer profile to create customized offer for the consumer; and e) prompting the CSR to provide the customized offer to the consumer.
33. A graphical user interface for a CSR to use to apply the method as described in example 1.
   34. A computer-implemented method for dynamic offer generation and content delivery to a customer by a customer service representative, such method comprising a) offering an offer/inducement to an inbound customer contact wherein the offer is not random but is selected by constructing, in real time, a customer profile using a plurality of harvested customer profile data and then matching the profile to an optimal marketing campaign (comprising the offer) based on one or more business rules and protocols; and b) processing an offer accepted by the customer (accepted offer); and c) transmitting accepted offer to the customer via a preferred communication means preselected by the customer.

We claim:

1. A computer-implementable method for selection and delivery of a customized offer to a consumer by a live customer service representative (CSR) in communication with said consumer comprising:
a) upon a first communication from the consumer to the CSR, enabling the CSR to acquire from a first computer system at least one identifying feature of said consumer;
b) using the at least one identifying feature to generate automatically, without CSR involvement, a search of the internet, via a second computer system, to acquire at least one current, real time internet content cue relating to said consumer, said real time internet content cue being collected while the CSR maintains engagement with the consumer;
c) processing, via the second computer system, the at least one identifying feature and the at least one current, real time internet content cue to generate a consumer profile for said consumer;
d) analyzing the consumer profile to create customized offer for the consumer;
e) prompting the CSR to provide the customized offer to the consumer; and f) tracking the outcome of the customized offer to analyze its effectiveness.

2. The method of claim 1 wherein at least one of the first computer system and the second computer system automatically and dynamically offers to the CSR a consumer communications script.

3. The method of claim 2 wherein the consumer communications script is updated by the first computer system based on one or more of 1) responses given by consumer to questions posed by CSR; 2) internet content cues; 3) the identifying feature; 4) the consumer profile; and 5) reaction of the consumer to the customized offer.

4. The method of claim 1 wherein the communication is selected from the group consisting of phone, email, SMS (text), Blackberry messenger (BBM), social media outlets, and other online means (including Skype, iChat, etc. . . . ).

5. The method of claim 1 wherein the first computer system acquires the at least one identifying feature of said consumer from a remote server with which it is in communication.

6. The method of claim 1 wherein the first computer system and the second computer system are the same.

7. The method of claim 1 wherein the CSR communication and prompts are enabled by an application operating on a CSR computer system.

8. The method of claim 1 wherein the generation of a customized offer for the consumer is enabled by a campaign management application on the second computer system.

9. The method of claim 1 wherein the second computer system is that of a customer care provider.

10. The method of claim 1 wherein the second computer system is that of a remote hosted website.

11. The method of claim 1 wherein the real time internet content cue is acquired from a social media outlet.

12. The method of claim 1 wherein the real time internet content cue is acquired from a social media outlet selected from the group consisting of collaborative projects, social networking sites, media sharing sites, review/opinion sharing sites, Internet forums, blogs, content communities, virtual game worlds, and virtual communities.

13. The method of claim 1 wherein the real time internet content cue is acquired from a social media outlet selected from the group consisting of Wikipedia, Myspace, Twitter, Facebook, Hootsuite, Flickr, YouTube, Pinterest, Google+, epinions, LinkedIn, Foursquare, WikiAnswers, weblogs, social blogs, and microblogs.

14. The method of claim 1 wherein, for said consumer, a new second profile is created upon the initiation of a second communication with the CSR, said second profile dynamically reflecting alterations in the consumer's internet content cues between the first communication and said second communication.

15. The method of claim 1 wherein the at least one identifying feature of said consumer is selected from the group consisting of any single or combination of said consumer's name, address, phone number, email address, social media outlet usernames, a unique identifier previously supplied to the consumer, a password, identification of a recent item purchased, age, gender, location, demographic data, employment, birthday, social insurance number, and family details.

16. The method of claim 1 wherein the consumer initiates a communication with the CSR for the purpose of discussing a warranty in relation to a product.

17. The method of claim 1 wherein the customized offer is a purchase incentive.

18. The method of claim 1 wherein the customized offer is a purchase incentive which is actionable by the consumer upon he/she posting a pre-agreed promotional statement on at least one of consumer's social media outlets.

19. A machine implemented system that selects and delivers a customized offer to a consumer via a live customer service representative (CSR) in communication with said consumer comprising the following machine executable components:
a device for live communication between the CSR and the consumer;
a first processor to acquire at least one identifying feature of said consumer;
a second processor to search the internet and to acquire at least one current, real time internet content cue relating to said consumer, to generate a consumer profile for said consumer based upon the at least one real time internet content cue and the at least one identifying feature and creating a customized offer for the consumer based at least in part on the consumer profile;
an interface for the CSR to add data relating to the consumer and to view the consumer profile and the customized offer.

20. The system of claim 19 wherein the first processor and the second processor include a means to communicate with the CSR to automatically and dynamically offer to the CSR a consumer communications script, viewable on the interface.

21. The system of claim 20 wherein the consumer communications script is updated by one of the first processor and the second processor based on one or more of 1) responses given by consumer to questions posed by CSR; 2) internet content cues; 3) the identifying feature; 4) the consumer profile; and 5) reaction of the consumer to the customized offer.

22. The system of claim 19 wherein the communication is selected from the group consisting of phone, email, SMS (text), Blackberry messenger (BBM), social media outlets, and other online means (including Skype, iChat, etc. . . . ).

23. The system of claim 19 wherein the first processor and the second processor are the same.

24. The system of claim 19 including a CSR computing system, engaged with the interface, said CSR computing system comprising an application which directs the CSR with dynamically updated language, script and prompts to engage the consumer.

25. The system of claim 19 comprising a campaign management application on the second processor.

26. The system of claim 19 wherein the real time internet content cue is acquired from a social media outlet.

27. The system of claim 19 wherein the real time internet content cue is acquired from a social media outlet selected from the group consisting of collaborative projects, social networking sites, media sharing sites, review/opinion sharing sites, Internet forums, blogs, content communities, virtual game worlds, and virtual communities.

28. The system of claim 19 wherein the real time internet content cue is acquired from a social media outlet selected from the group consisting of Wikipedia, Myspace, Twitter, Facebook, Hootsuite, Flickr, YouTube, Pinterest, Google+, epinions, LinkedIn, Foursquare, WikiAnswers, weblogs, social blogs, and microblogs.

29. A networked apparatus for use by a customer service representative (CSR) in live communication with a consumer comprising: a memory; a processor; a communicator; a display; and a data receiving module to receive a consumer profile and customized offer for said consumer, said profile generated by the analysis of at least one identifying feature and the at least one current, real time internet content cue related to said consumer, said display comprising an interface for the CSR to add data relating to the consumer and to view the consumer profile and the customized offer.

30. The apparatus of claim 29 wherein said interface automatically and dynamically offers to the CSR a consumer communications script.

31. Non-transitory, computer-readable storage media for tangibly storing thereon computer readable instructions for a method for the selection and delivery of a customized offer to a consumer by a live customer service representative (CSR) in communication with said consumer, said method comprising: a) upon a first communication from the consumer to the CSR, enabling the CSR to acquire from a first computer system at least one identifying feature of said consumer; b) using the at least one identifying feature to generate automatically, without CSR involvement, a search of the internet, via a second computer system, to acquire at least one current, real time internet content cue relating to said consumer, said real time internet content cue being collected while the CSR maintains engagement with the consumer; c) processing, via the second computer system, the at least one identifying feature and the at least one current, real time internet content cue to generate a consumer profile for said consumer; d) analyzing the consumer profile to create customized offer for the consumer; e) prompting the CSR to provide the customized offer to the consumer; and f) tracking and analyzing an outcome of the offer.
